(19) United States
(12) Patent Application Publication
(10) Pub. No.: US 2013/0223518 A1
(43) Pub. Date: Aug. 29, 2013

(54) IMAGE CODING METHOD, IMAGE DECODING METHOD, IMAGE CODING APPARATUS, IMAGE DECODING APPARATUS, AND IMAGE CODING AND DECODING APPARATUS

(71) Applicant: Panasonic Corporation, (US)

(72) Inventors: Youji Shibahara, Osaka (JP); Takahiro Nishi, Nara (JP); Toshiyasu Sugio, Osaka (JP); Kyoko Tanikawa, Osaka (JP); Toru Matsunobu, Osaka (JP); Hisao Sasai, Osaka (JP); Kengo Terada, Osaka (JP); Yasuhiro Mamiya, Aichi (JP)

(73) Assignee: PANASONIC CORPORATION, Osaka (JP)

(21) Appl. No.: 13/760,381

(22) Filed: Feb. 6, 2013

Related U.S. Application Data
(60) Provisional application No. 61/596,566, filed on Feb. 8, 2012.

(51) Int. Cl. H04N 7/26

(52) U.S. Cl. CPC H04N 19/00781
USPC 375/240.03

(57) ABSTRACT

An image coding method includes: node processing on a node in a tree structure; and coding on a frequency coefficient of an image block of a leaf node in the tree structure or a frequency coefficient of an image block of its parent node. The node processing includes: when the node processing is performed on a parent node having child nodes, assigning a position of an image block of a current child node and a position of an image block of the parent node, to arguments of the node processing, and recursively calling the node processing for the child node; and when the node processing is performed on a leaf node, assigning a position of an image block of the leaf node and a position of an image block of a parent node of the leaf node, to arguments of the coding processing, and calling the coding processing.

### CROSS REFERENCE TO RELATED APPLICATION

The present application claims the benefit of U.S. Provisional Patent Application No. 61/596,566 filed Feb. 8, 2012. The entire disclosure of the above-identified application, including the specification, drawings and claims is incorporated herein by reference in its entirety.

### FIELD

One or more exemplary embodiments disclosed herein relate to image coding methods of coding image.

### BACKGROUND

Conventionally, an example of image coding methods of coding image is disclosed in Non Patent Literature 1.

### CITATION LIST

### Non Patent Literature

[NPL 1] ITU-T Recommendation H.264 “Advanced video coding for generic audiovisual services”, March 2010

### Summary

### Technical Problem

However, it is difficult for image coding apparatuses with low performance to perform image coding methods requiring a large calculation amount.

One non-limiting and exemplary embodiment provides an image coding method capable of reducing a calculation amount in coding image.

### Solution to Problem

In one general aspect, the techniques disclosed here feature an image coding method comprising: performing node processing on a node from among nodes in a tree structure having relationships by which each of image blocks generated by splitting an image block corresponding to a parent node into child nodes corresponds to a corresponding one of the child nodes; and performing coding processing of coding one of (a) a frequency coefficient of an image block corresponding to a leaf node in the tree structure and (b) a frequency coefficient of an image block corresponding to a parent node of the leaf node, wherein the performing of the node processing includes: when the node processing is performed on a parent node having child nodes, (i) assigning (a) a position of an image block corresponding to a current child node from among the child nodes and (b) a position of an image block corresponding to the parent node, to arguments of the node processing, and (ii) recursively calling the node processing for the current child node, and when the node processing is performed on a leaf node, (i) assigning (a) a position of an image block corresponding to the leaf node and (b) a position of an image block corresponding to a parent node of the leaf node, to arguments of the coding processing, and (ii) calling the coding processing.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

Additional benefits and advantages of the disclosed embodiments will be apparent from the Specification and Drawings. The benefits and/or advantages may be individually obtained by the various embodiments and features of the Specification and Drawings, which need not all be provided in order to obtain one or more of such benefits and/or advantages.

### Advantageous Effects

The image coding method according to one or more exemplary embodiments or features disclosed herein is capable of reducing a calculation amount in coding image.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a flowchart of an image coding method according to a reference example.

FIG. 2 is a block diagram of an image coding apparatus according to Embodiment 1.

FIG. 3 is a block diagram of an image decoding apparatus according to Embodiment 1.

FIG. 4 is a flowchart of coding a tree structure of a transform unit according to Embodiment 1.

FIG. 5 is a flowchart of coding an anterior half of the tree structure of the transform unit according to Embodiment 1.

FIG. 6 is a flowchart of coding a latter half of the tree structure of the transform unit according to Embodiment 1.

FIG. 7 is a block diagram of details of a part of the image decoding apparatus according to Embodiment 1.

FIG. 8 is a flowchart of coding a tree structure of a transform unit according to Embodiment 2.

FIG. 9A is a flowchart of coding a chrominance signal in the tree structure of the transform unit according to Embodiment 2.

FIG. 9B is a flowchart of coding two components of chrominance signals in the tree structure of the transform unit according to Embodiment 2.

FIG. 10 is a block diagram of details of a part of an image decoding apparatus according to Embodiment 2.

FIG. 11A is a diagram of coding CBFs according to Embodiment 2.

FIG. 11B is a diagram of the first example of coding elimination according to Embodiment 2.

FIG. 11C is a diagram of the second example of coding elimination according to Embodiment 2.

FIG. 11D is a diagram of the third example of coding elimination according to Embodiment 2.

FIG. 12 is a flowchart of coding a tree structure of a transform unit according to Embodiment 3.

FIG. 13A is a diagram of the first example of an order of coding CBFs and transform coefficients according to Embodiment 4.

FIG. 13B is a diagram of the second example of the order of coding CBFs and transform coefficients according to Embodiment 4.

FIG. 13C is a diagram of the third example of the order of coding CBFs and transform coefficients according to Embodiment 4.

FIG. 13D is a diagram of the fourth example of the order of coding CBFs and transform coefficients according to Embodiment 4.

FIG. 14 is a flowchart of coding a tree structure of a transform unit according to Embodiment 4.

FIG. 15A is a diagram of the fifth example of the order of coding CBFs and transform coefficients according to Embodiment 4.

FIG. 15B is a diagram of the sixth example of the order of coding CBFs and transform coefficients according to Embodiment 4.

FIG. 16A is a flowchart of the first example of coding a tree structure of a transform unit according to Embodiment 5.

FIG. 16B is a flowchart of the second example of coding a tree structure of a transform unit according to Embodiment 5.

FIG. 17A is a flowchart of a main routine according to Embodiment 6.

FIG. 17B is a flowchart of a sub routine according to Embodiment 6.

FIG. 18A is a flowchart of a specific example of the main routine according to Embodiment 6.

FIG. 18B is a flowchart of a specific example of the sub routine according to Embodiment 6.

FIG. 19A is a diagram of a syntax of a CU according to Embodiment 6.

FIG. 19B is a diagram of a syntax of a CU according to Embodiment 6.

FIG. 20A is a diagram of a syntax of a tree structure of a transform unit according to Embodiment 6.

FIG. 20B is a diagram of a syntax of a tree structure of a transform unit according to Embodiment 6.

FIG. 20C is a diagram of a syntax of a tree structure of a transform unit according to Embodiment 6.

FIG. 21 is a diagram of a syntax of a transform unit according to Embodiment 6.

FIG. 22 is a block diagram of an image coding apparatus according to Embodiment 7.

FIG. 23 is a flowchart of an image coding apparatus according to Embodiment 7.

FIG. 24 is a block diagram of an image decoding apparatus according to Embodiment 7.

FIG. 25 is a flowchart of an image decoding apparatus according to Embodiment 7.

FIG. 26 shows an overall configuration of a content providing system for implementing content distribution services.

FIG. 27 shows an overall configuration of a digital broadcasting system.

FIG. 28 shows a block diagram illustrating an example of a configuration of a television.

FIG. 29 shows a block diagram illustrating an example of a configuration of an information reproducing/recording unit that reads and writes information from and on a recording medium that is an optical disk.

FIG. 30 shows an example of a configuration of a recording medium that is an optical disk.

FIG. 31A shows an example of a cellular phone.

FIG. 31B is a block diagram showing an example of a configuration of a cellular phone.

FIG. 32 illustrates a structure of multiplexed data.

FIG. 33 schematically shows how each stream is multiplexed in multiplexed data.

FIG. 34 shows how a video stream is stored in a stream of PES packets in more detail.

FIG. 35 shows a structure of TS packets and source packets in the multiplexed data.

FIG. 36 shows a data structure of a PMT.

FIG. 37 shows an internal structure of multiplexed data information.

FIG. 38 shows an internal structure of stream attribute information.

FIG. 39 shows steps for identifying video data.

FIG. 40 shows an example of a configuration of an integrated circuit for implementing the moving picture coding method and the moving picture decoding method according to each of embodiments.

FIG. 41 shows a configuration for switching between driving frequencies.

FIG. 42 shows steps for identifying video data and switching between driving frequencies.

FIG. 43 shows an example of a look-up table in which video data standards are associated with driving frequencies.

FIG. 44A is a diagram showing an example of a configuration for sharing a module of a signal processing unit.

FIG. 44B is a diagram showing another example of a configuration for sharing a module of the signal processing unit.

### DESCRIPTION OF EMBODIMENTS

(Underlying Knowledge Forming Basis of the Present Disclosure)

The inventors have found the following problems in image coding methods of coding image. The following is the details.

In order to compress audio data and video data, various audio coding standards and video coding standards have been developed. Examples of such video coding standards are International Telecommunication Union Telecommunication Standardization Sector (ITU-T) standard called H.26× and International Organization for Standardization/International Electrotechnical Commission (ISO/IEC) standard called MPEG-x. The latest video coding standard is called H.264/MPEG-4AVC. Recently, a new-generation coding standard called High Efficiency Video Coding (HEVC) has been examined.

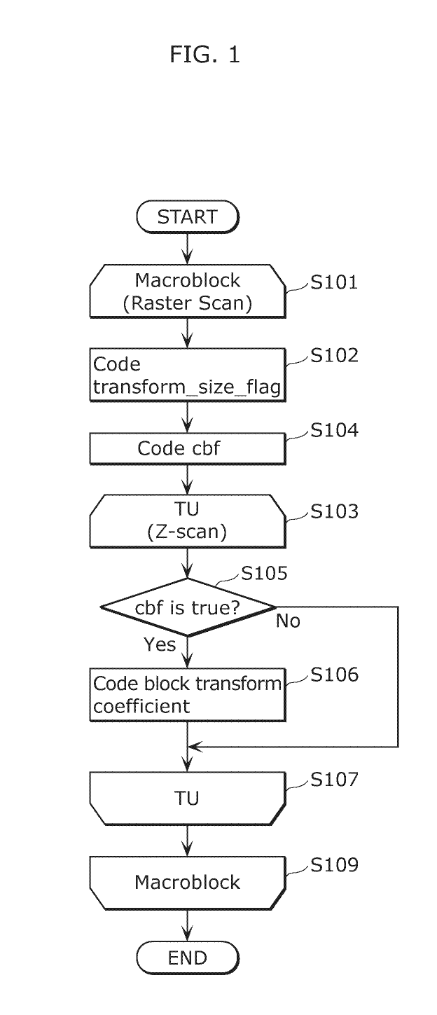

FIG. 1 is a flowchart of a method of coding spit information of a transform unit, a flag (CBF) indicating whether or not there is a transform coefficient, the transform coefficient of the transform unit, and the like.

Here, the transform coefficient sometimes has the same meaning as a quantization coefficient or a frequency coefficient which will be described later. The transform coefficient is referred to also as a block transform coefficient, BlockCoeff, block_coeff, or the like. The transform unit is referred to also as a TU. The spit information of a transform unit is referred to also as a TUS or split_transform_flag. More specifically, the spit information of a transform unit is a flag indicating whether or not the transform unit is to be split into pieces.

When a current picture or frame is coded, macroblocks each having the same size of 16 pixels×16 pixels in the picture or frame are coded in a raster scan order. For a current macroblock to be coded (S101), the image coding apparatus can select between orthogonal transform (frequency transform) having a size of 4 pixels×4 pixels and orthogonal transform having a size of 8 pixels×8 pixels (S102). A flag indicating such a size for transform is referred to, for example, as transform_size_flag.

As a transform size is smaller than a macroblock, the image coding apparatus transforms blocks sequentially in a Z-scan order (S103). Here, a unit for transform is referred to as a transform unit (TU). For a macroblock, a CBF is coded (S104). The processing is switched according to whether the CBF is true or false (S105). If the CBF is true, then a transform coefficient having a size of a transform unit is coded (S106). On the other hand, if the CBF is false, the transform coefficient is not coded. The image coding apparatus repeats the above processing for each of transform units.

In order to improve a coding efficiency, it is desirable that a transform unit size and a coding unit size for a macroblock is adaptively changeable. However, the adaptive change of these sizes would increase a calculation amount.

According to an exemplary embodiment disclosed herein, an image coding method includes: performing node processing on a node from among nodes in a tree structure having relationships by which each of image blocks generated by splitting an image block corresponding to a parent node into child nodes corresponds to a corresponding one of the child nodes; and performing coding processing of coding one of (a) a frequency coefficient of an image block corresponding to a leaf node in the tree structure and (b) a frequency coefficient of an image block corresponding to a parent node of the leaf node, wherein the performing of the node processing includes: when the node processing is performed on a parent node having child nodes, (i) assigning (a) a position of an image block corresponding to a current child node from among the child nodes and (b) a position of an image block corresponding to the parent node, to arguments of the node processing, and (ii) recursively calling the node processing for the current child node, and when the node processing is performed on a leaf node, (i) assigning (a) a position of an image block corresponding to the leaf node and (b) a position of an image block corresponding to a parent node of the leaf node, to arguments of the coding processing, and (ii) calling the coding processing.

In this way, even if the frequency coefficient of the image block at the parent node is to be coded, it is possible to eliminate calculation of the position of the image block. As a result, a calculation amount in coding image is reduced.

For example, the image coding method may further include performing frequency transform and quantization on a prediction error between (a) one of (a−1) a pixel value of an image block corresponding to a leaf node in the tree structure and (a−2) a pixel value of an image block corresponding to a parent node of the leaf node and (b) a prediction pixel value, thereby generating the frequency coefficient, wherein in the performing of the coding processing, the generated frequency coefficient is coded.

In this way, the frequency coefficient corresponding to the prediction error is coded. As a result, a coding efficiency is increased.

For example, it is possible that when the image block corresponding to the leaf node has a predetermined minimum size and a total number of pieces of data of a chrominance value of the image block corresponding to the leaf node is less than a total number of pieces of data of a luminance value, the performing of the coding processing includes: (i) specifying the image block corresponding to the parent node of the leaf node according to the position of the image block corresponding to the parent node; and (ii) coding a frequency coefficient of a chrominance value of the image block corresponding to the parent node, the position of the image block corresponding to the parent node being assigned to one of the arguments of the coding processing.

In this way, if predetermined conditions are satisfied, the frequency coefficient of the image block at the parent node is coded. Even in such a case, it is possible to eliminate calculation of the position of the image block. As a result, a calculation amount in coding image is reduced.

For example, it is possible that in the performing of the node processing, the node processing is performed on the nodes in the tree structure that has (a) a root node corresponding to a coding unit of an image and (b) a leaf node corresponding to a transform unit of a luminance value in the coding unit.

In this way, processing is appropriately performed based on (a) the coding unit included in the image and (b) the transform unit included in the coding unit.

According to another exemplary embodiment disclosed herein, an image decoding method includes: performing node processing on a node from among nodes in a tree structure having relationships by which each of image blocks generated by splitting an image block corresponding to a parent node into child nodes corresponds to a corresponding one of the child nodes; and performing decoding processing of decoding one of (a) a frequency coefficient of an image block corresponding to a leaf node in the tree structure and (b) a frequency coefficient of an image block corresponding to a parent node of the leaf node, wherein the performing of the node processing includes: when the node processing is performed on a parent node having child nodes, (i) assigning (a) a position of an image block corresponding to a current child node from among the child nodes and (b) a position of an image block corresponding to the parent node, to arguments of the node processing, and (ii) recursively calling the node processing for the current child node, and when the node processing is performed on a leaf node, (i) assigning (a) a position of an image block corresponding to the leaf node and (b) a position of an image block corresponding to a parent node of the leaf node, to arguments of the decoding processing, and (ii) calling the decoding processing.

In this way, even if the frequency coefficient of the image block at the parent node is to be decoded, it is possible to eliminate calculation of the position of the image block. As a result, a calculation amount in decoding image is reduced.

For example, the image decoding method may include adding a prediction pixel value to a prediction error generated by performing inverse quantization and inverse frequency transform on the decoded frequency coefficient, thereby reconstructing one of (a) a pixel value of an image block corresponding to a leaf node in the tree structure and (b) a pixel value of an image block corresponding to a parent node of the leaf node.

In this way, the pixel value is appropriately reconstructed from the decoded frequency coefficient by the inverse quantization, the inverse frequency transform, the prediction, and the like.

For example, it is possible that when the image block corresponding to the leaf node has a predetermined minimum size and a total number of pieces of data of a chrominance value of the image block corresponding to the leaf node is less than a total number of pieces of data of a luminance value, the performing of the decoding processing includes: (i) specifying the image block corresponding to the parent node of the leaf node according to the position of the image block corresponding to the parent node, and (ii) decoding a frequency coefficient of a chrominance value of the image block corresponding to the parent node, the position of the image block corresponding to the parent node being assigned to one of the arguments of the decoding processing.

In this way, if predetermined conditions are satisfied, the frequency coefficient of the image block at the parent node is decoded. Even in such a case, it is possible to eliminate calculation of the position of the image block. As a result, a calculation amount in decoding image is reduced.

For example, it is possible that in the performing of the node processing, the node processing is performed on the nodes in the tree structure that has (a) a root node corresponding to a coding unit of an image and (b) a leaf node corresponding to a transform unit of a luminance value in the coding unit.

In this way, processing is appropriately performed based on (a) the coding unit included in the image and (b) the transform unit included in the coding unit.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

The following describes the embodiments with reference to the drawings. Each of the exemplary embodiments described below shows a general or specific example. The numerical values, shapes, materials, structural elements, the arrangement and connection of the structural elements, steps, the processing order of the steps etc. shown in the following exemplary embodiments are mere examples, and therefore do not limit the scope of the appended Claims and their equivalents. Therefore, among the structural elements in the following exemplary embodiments, structural elements not recited in any one of the independent claims are described as arbitrary structural elements.

It should be noted that the same reference numerals are assigned to identical structural elements or identical steps in the drawings to prevent repetition of explaining them.

It should also be noted that coding is mainly described in the following description, but if “code” is replaced by “decode”, decoding processing is achieved in the same manner as described for coding processing. In other words, “code” may be replaced by “decode”. Reversely, “decode” may be replaced by “code”.

### Embodiment 1

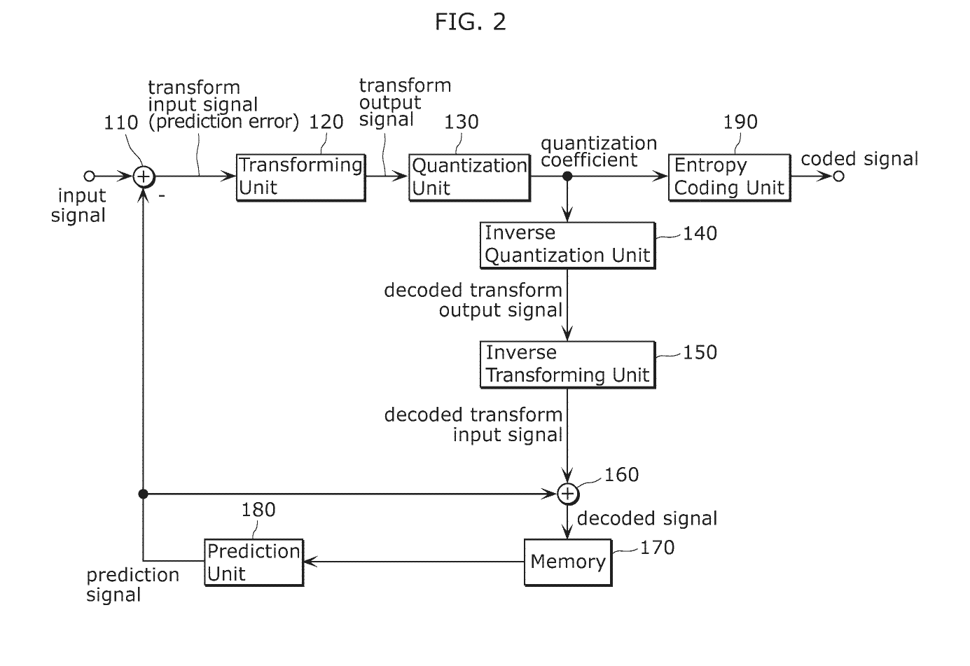

FIG. 2 is a block diagram of an image coding apparatus according to the present embodiment. A subtractor 110 generates a prediction error signal (transform input signal) that is a difference signal between an input signal and a prediction signal. The subtractor 110 provides the prediction error signal to a transforming unit 120. The transforming unit 120 performs frequency transform on the transform input signal to generate a transform output signal. The transforming unit 120 transforms, from a spatial domain to a frequency domain, the input signal that indicates various pieces of information or the transform input signal generated by performing certain processing on the input signal. As a result, the transforming unit 120 generates a transform output signal having decreased correlation.

The quantization unit 130 quantizes the transform output signal provided from the transforming unit 120, thereby generating a quantization coefficient having a small total amount of data. An entropy coding unit 190 codes, by using an entropy coding algorithm, the quantization coefficient provided from the quantization unit 130, thereby generating a coded signal having further compressed redundancy. An inverse quantization unit (iQ) 140 inversely quantizes the quantization coefficient to generate a decoded transform output signal. An inverse transforming unit (iT) 150 inversely transforms the decoded transform output signal to generate a decoded transform input signal.

The adder 160 adds the decoded transform input signal with a prediction signal to generate a decoded signal. A memory 170 stores the decoded signal. A prediction unit 180 obtains a predetermined signal from the memory 170 according to a prediction method, and generates a prediction signal according to the prediction method. In the image coding apparatus, the prediction unit 180 determines a prediction method resulting in a maximum coding efficiency, and outputs information of the determined prediction method (prediction method information). An entropy coding unit 190 performs entropy coding on the prediction method information, as needed.

The inverse quantization unit 140, the inverse transforming unit 150, the adder 160, the memory 170, and the prediction unit 180 are also included in an image decoding apparatus. The decoded signal is referred to also as a reproduced image signal.

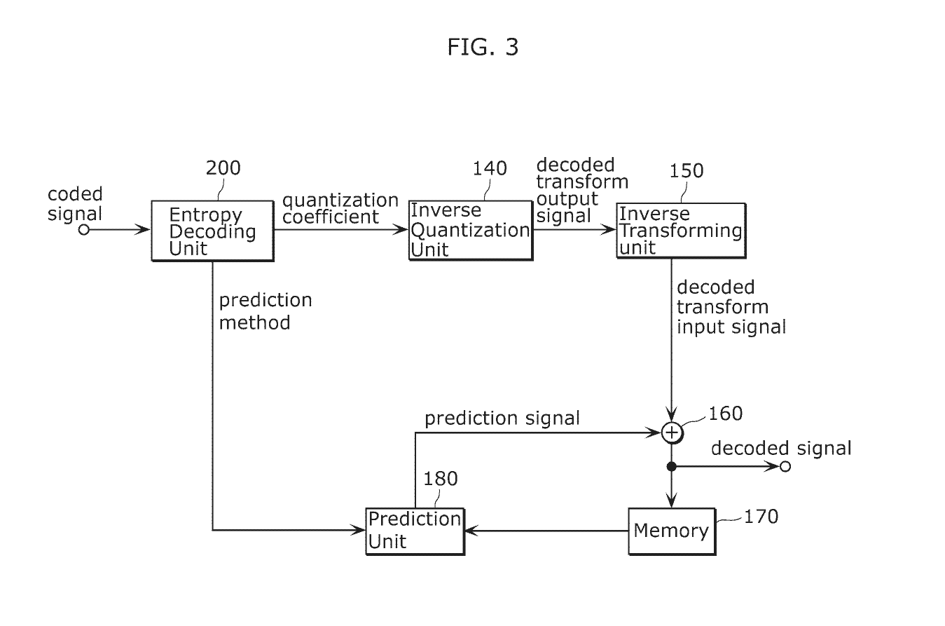

FIG. 3 is a block diagram of an image decoding apparatus according to the present embodiment. An entropy decoding unit 200 performs entropy decoding on an input coded signal to obtain a quantization coefficient and a prediction method (including an intra prediction mode and the like). An inverse quantization unit 140 performs inverse quantization on the quantization coefficient to generate a decoded transform output signal, and provides the decoded transform output signal to the inverse transforming unit 150. The inverse transforming unit 150 performs inverse transform on the decoded transform output signal to generate a decoded transform input signal. The adder 160 adds the decoded transform input signal with a prediction signal. As a result, a decoded signal is generated.

The decoded signal is a reproduced image signal generated by the image decoding apparatus. The decoded signal is outputted from the image decoding apparatus and then stored in the memory 170. The prediction unit 180 obtains a predetermined signal from the memory 170 according to a prediction method, and generates a prediction signal according to the prediction method.

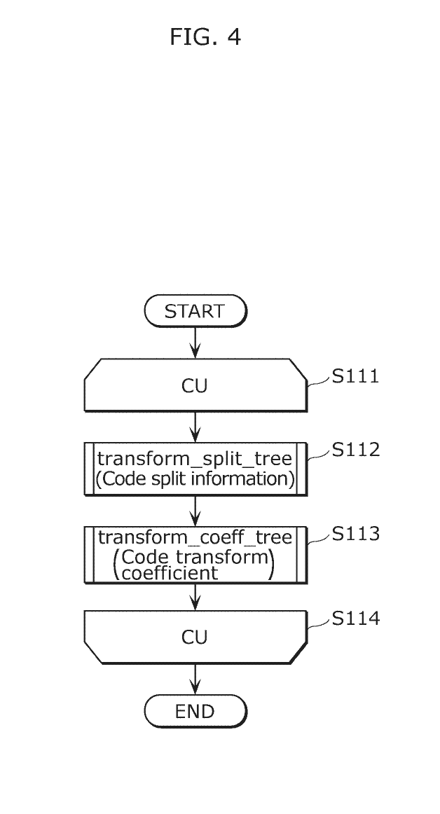

FIG. 4 is a flowchart of a method of coding spit information of a transform unit, a flag (CBF) indicating whether or not there is a transform coefficient, the transform coefficient of the transform unit, and the like according to the present embodiment. The coding is performed, for example, by the entropy coding unit 190 in the image coding apparatus.

According to flexible selection of a transform size, split of a transform unit is expressed by a tree structure. This tree structure has pieces of spit information (TUS) of respective transform units as nodes. The spit information is, for example, a flag indicating whether or not the corresponding transform unit is to be split into pieces.

For a current coding unit (CU) from among CUs generated by splitting a current picture or frame (S111), the image coding apparatus codes pieces of information such as a transform size in the TUS tree structure (S112). In addition, in coding the TUS tree structure, the image coding apparatus codes a CBF indicating whether or not there is a transform coefficient of a current transform unit. Hereinafter, this step is referred to also as transform_split_tree processing.

Next, according to the transform size, position information of the transform unit, and the above-described CBF which are expressed in the TUS tree structure, the transform coefficient is coded (S113). Hereinafter, this step is referred to also as transform_coeff_tree processing.

The image coding apparatus repeats the above-described processing for each of the CUs in the picture (S114). The tree structure expression allows the image coding apparatus to flexibly change a size of the transform units included in the CU depending on features or the like of the image. It should be noted that the CBF may be coded at S113 not at S112.

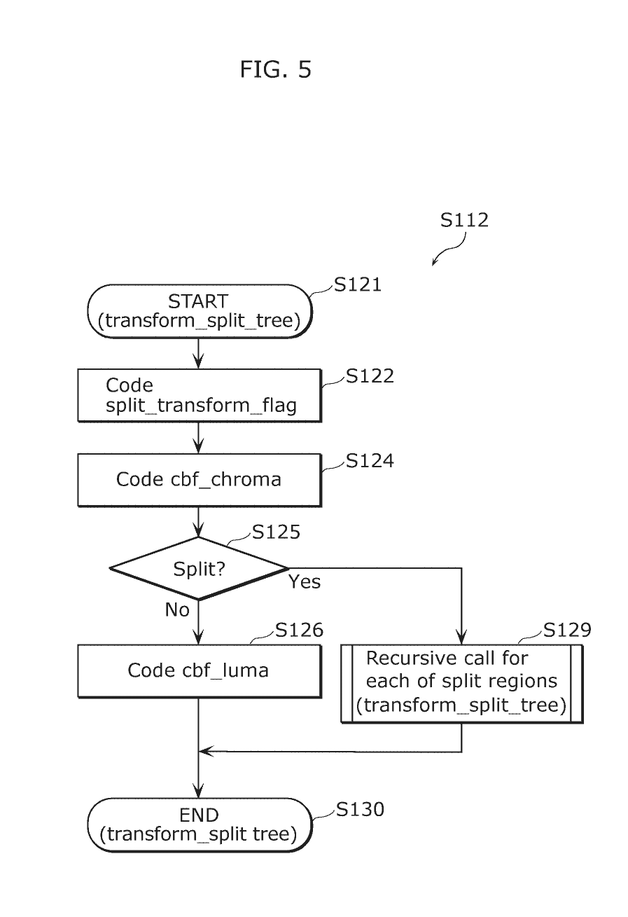

FIG. 5 is a flowchart of the above-described step (S112: transform_split_tree) for coding the TUS tree structure. The transform_split_tree processing is recursively defined (S121). A recursive level in the tree structure is called a transform depth (TrD).

The image coding apparatus codes a TUS (split_transform_flag) at a current TrD (S122). Next, as a data amount of a transform coefficient of chrominance signal is likely to be zero, the image coding apparatus codes, for a block that has not yet been split, a flag (cbf_chroma) indicating whether or not there is a transform coefficient of chrominance signal (S124).

It should be noted that the TUS may be exchanged with cbf_chroma in the coding order. If cbf_chroma is coded prior to the TUS, the image coding apparatus can shorten a wait time from when the TUS is obtained until when it is determined (S125) based on the TUS whether or not next splitting is to be performed. Therefore, the TUS can be stored in a high-speed cache memory or the like. As a result, it is possible to reduce a memory having a large capacity and increase a speed.

Furthermore, the coding of cbf_chroma prior to the TUS means that information indicating whether or not there is the transform coefficient of the transform unit is coded prior to splitting. Therefore, the information indicating whether or not there is the transform coefficient of the transform unit is coded with a larger size. Chrominance signal is less likely to have a transform coefficient than luminance signal. If chrominance signal is coded with a large size, a coding efficiency is likely to be increased. Therefore, the image coding apparatus sends cbf_chroma of a large size (codes cbf_chroma prior to the TUS). As a result, there is a possibility of increasing a coding efficiency.

Referring back to FIG. 5, the explanation continues. The image coding apparatus determines, based on the TUS, whether or not the current transform unit is to be further split into pieces (S125). If the current transform unit is to be further split into pieces, the image coding apparatus spatially splits the transform unit into four regions, and recursively performs the transform_split_tree processing for each of the regions (S129). On the other hand, if the current transform unit is not to be further split into pieces, the image coding apparatus codes a flag (cbf_luma) indicating whether or not there is a transform coefficient of the transform unit for luminance signal (S126).

With that, the processing for a certain end of the tree is completed (S130), and the processing proceeds to an upper level (a parent node of the leaf node in the tree structure) of a recursive call. When transform sizes, CBFs, and the like have been coded for all of the regions in the current CU, the transform_split_tree processing is completed.

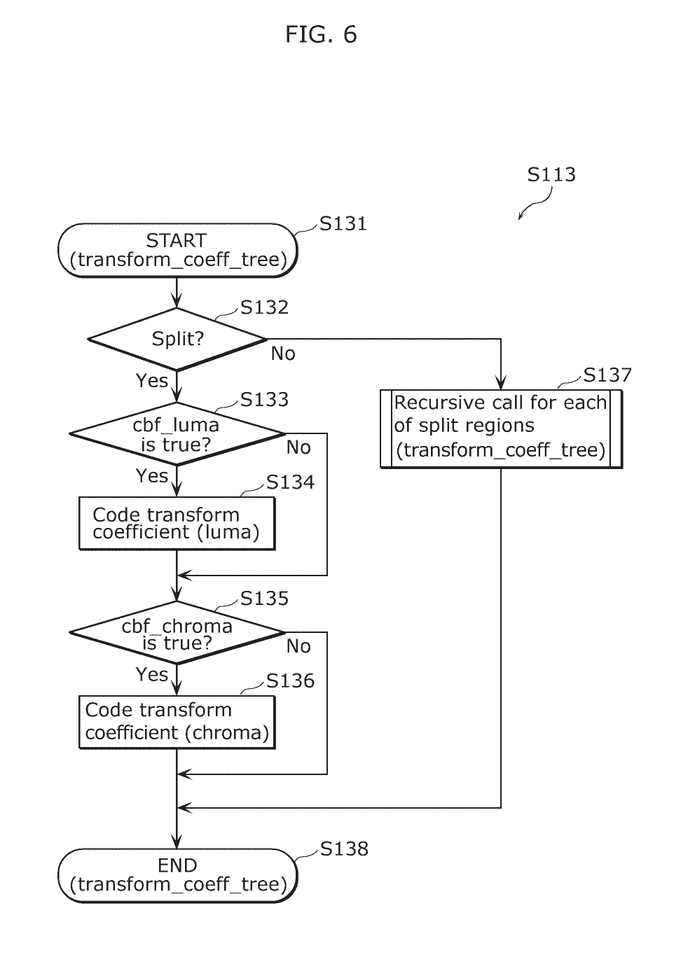

FIG. 6 is a flowchart of the above-described step (S113: transform_coeff_tree) for coding a transform coefficient based on a TUS and a CBF.

The transform_coeff_tree processing is recursively defined (S131). The transform_coeff_tree processing at a recursive level is changed according to whether a previously coded TUS is true or false (S132).

If the TUS is true, the image coding apparatus spatially splits the transform unit into four regions, and recursively performs the transform_coeff_tree processing for each of the regions (S137).

On the other hand, if the current transform unit is not to be split, the processing is determined according to previously obtained cbf_luma. If cbf_luma is true, then a transform coefficient of luminance signal is coded (S134). Next, the processing is determined according to previously obtained cbf_chroma. If cbf_chroma is true, then a transform coefficient of chrominance signal is coded (S136).

With that, the processing for a certain end of the tree is completed (S138), and the processing proceeds to an upper level (a parent node of the leaf node in the tree structure) of a recursive call. When traverse (search or circuit) of the TUS tree structure is completed for all of the regions in the current CU and therefore transform coefficients have been coded, the transform_coeff_tree processing is completed.

It should be noted that in each of the flowcharts of FIGS. 4, 5, and 6, “code” may be replaced by “decode”. As a result, flowcharts of an image decoding method performed by the image decoding apparatus can be obtained.

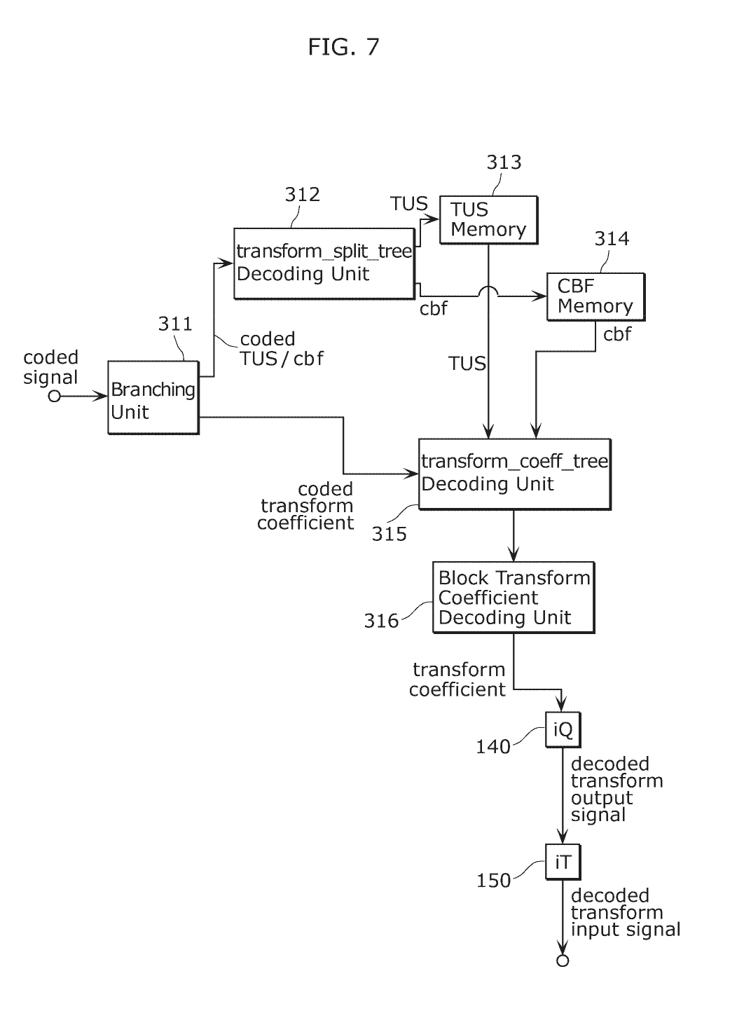

FIG. 7 is a block diagram of details of a part of the image decoding apparatus according to the present embodiment. The processing is selectively switched according to a kind of a current coded signal. A coded TUS and a coded CBF are selected by a branching unit 311 (DeMux unit, for example) and then provided to a transform_split_tree decoding unit 312. The transform_split_tree decoding unit 312 recursively circulates in the tree structure, thereby outputting a TUS and a CBF.

The TUS is stored in a TUS memory 313 that is a temporary memory. All of TUSs in a current CU are stored. In addition, the CBF is stored into a CBF memory 314 that is another temporary memory. All of CBFs in the current CU are stored in the CBF memory 314.

After the TUS and the CBF of the current CU have been decoded, the branching unit 311 provides the transform_coeff_tree decoding unit 315 with a coded transform coefficient. The transform_coeff_tree decoding unit 315 reads the TUS from the above-described TUS memory 313, then performs traverse based on the TUS, and reads the CBF from the above-described CBF memory 314. Then, the transform_coeff_tree decoding unit 315 associates the coded transform coefficient with a transform unit having the CBF that is true.

The coded transform coefficient is provided from the transform_coeff_tree decoding unit 315 to a block transform coefficient decoding unit 316 to be applied with entropy decoding. As a result, a transform coefficient is generated. The transform coefficient is inversely quantized by the inverse quantization unit 140. Then, a decoded transformed output signal is outputted. The inverse transforming unit 150 performs inverse transform on the decoded transform output signal. As a result, a decoded transformed input signal is outputted.

The image coding apparatus according to the present embodiment uses the tree structure to reduce an overhead of coding a transform coefficient and the like of a transform unit. Moreover, for each of the transform_split_tree processing and the transform_coeff_tree processing, it is possible to separately perform optimization of an operation speed and the like.

### Embodiment 2

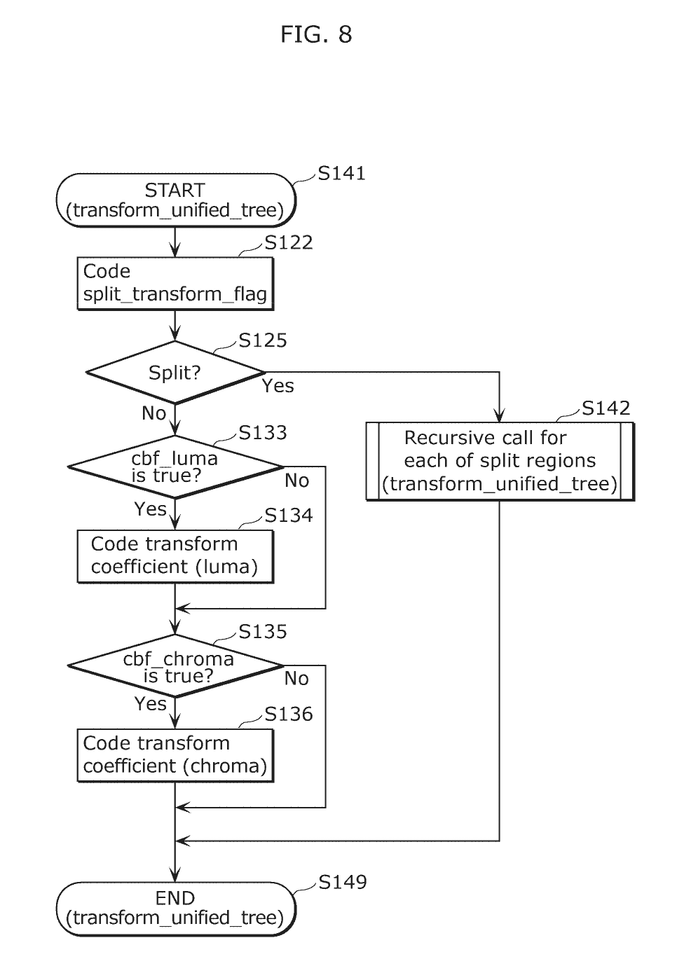

FIG. 8 is a flowchart of a method of coding spit information of a transform unit, a flag (CBF) indicating whether or not there is a transform coefficient, the transform coefficient of the transform unit, and the like according to the present embodiment.

The image coding apparatus codes a transform unit size into a TUS tree structure, for a current coding unit (CU) that is a unit for coding a picture or frame. In addition, in coding the TUS tree structure, the image coding apparatus codes a CBF indicating whether or not there is a transform coefficient of a current transform unit. At an end of the TUS tree structure, if a CBF of a current transform unit is true, a corresponding transform coefficient is coded.

The coding of such information is explained based on transform_unified_tree processing corresponding to processing performed for a current transform depth (S141).

First, at a current transform depth, a TUS (split_transform_flag) indicating whether or not a current block is to be split into pieces is coded (S122). Next, the processing is determined according to the TUS (S125). If the TUS is true, then the image coding apparatus splits the transform unit into further four regions, and recursively calls the transform_unified_tree processing for each of the regions. On the other hand, if the TUS is false, then the image coding apparatus does not split the transform unit, and performs processing in consideration that the current level is an end of the tree structure.

Here, the processing is determined according to whether or not cbf_luma coded in the transform_unified_tree is true or false (S133). Only if cbf_luma is true, the image coding apparatus codes a transform coefficient of luminance signal of the current block (S134). Next, the processing is determined according to whether or not cbf_chroma coded in the transform_unified_tree is true or false (S135). Only if cbf_chroma is true, the image coding apparatus codes a transform coefficient of chrominance signal of the current block (S136).

With that, the processing for the end of the tree is completed (S149), and the processing proceeds to an upper level (a parent node of the leaf node in the tree structure) of a recursive call. When transform sizes, CBFs, and the like have been coded for all of the regions in the current CU, the transform_unified_tree processing is completed.

The flow according to Embodiment 2 differs from the flow according to Embodiment 1 in that not only a CBF but also a transform coefficient are coded at an end of the TUS tree structure. In the method according to Embodiment 1, coding is performed on the two tree structures that are transform_split_tree and transform_coeff_tree, and traverse is performed on the two tree structures. In the method according to Embodiment 2, however, the processing is performed on a single tree structure only. Therefore, a processing amount performed by the apparatus and the method is reduced.

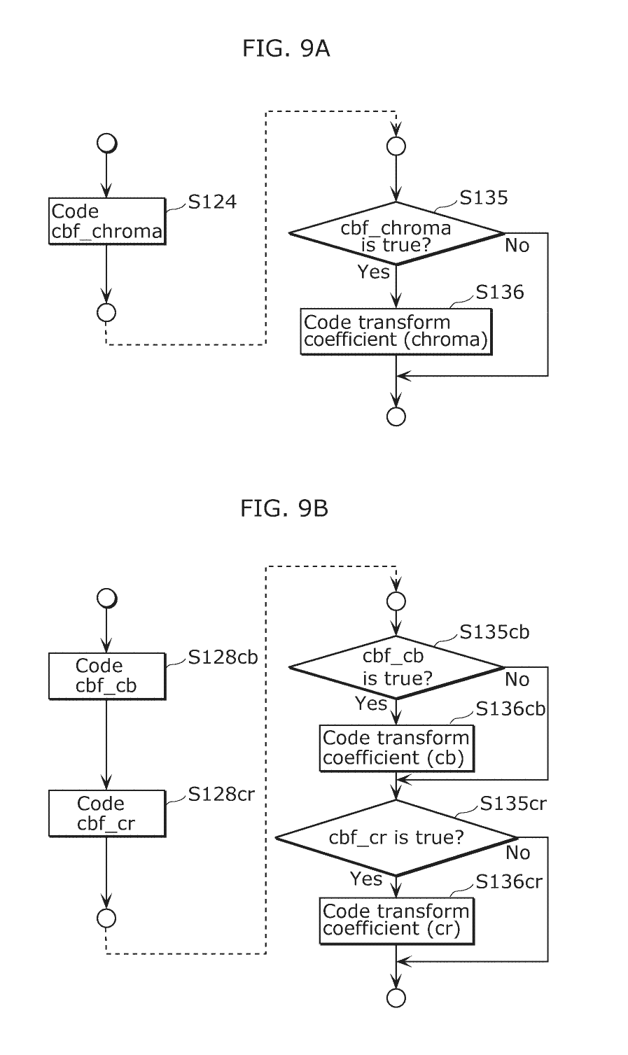

Each of FIGS. 9A and 9B is a diagram showing an excerption of processing for a CBF and a transform coefficient of chrominance signal. FIG. 9A corresponds to FIG. 8. cbf_chroma is coded at a certain time in the transform_unified_tree processing (S124). After that, although some steps may be inserted, only if cbf_chroma is true (Yes at S135), a transform coefficient of chrominance signal of a current transform unit is coded (S136).

In FIG. 9A, for the sake of simplicity in the description, a Cb component of chrominance signal is not distinguished from a Cr component of chrominance signal. In practice, these components are distinguished as shown in FIG. 9B. At a certain time in the transform_unified_tree processing, a flag (cbf_cb) indicating whether or not there is a transform coefficient of a Cb component of chrominance signal is coded (S128cb). In addition, at a certain time in the transform_unified_tree processing, a flag (cbf_cr) indicating whether or not there is a transform coefficient of a Cr component of chrominance signal is coded (S128cr).

After that, although some steps may be inserted, only if cbf_cb is true (Yes at S135cb), a transform coefficient of a Cb component of chrominance signal is coded (S136cb). Then, only if cbf_cr is true (Yes at S135cr), then a transform coefficient of a Cr component of chrominance signal is coded (S136cr).

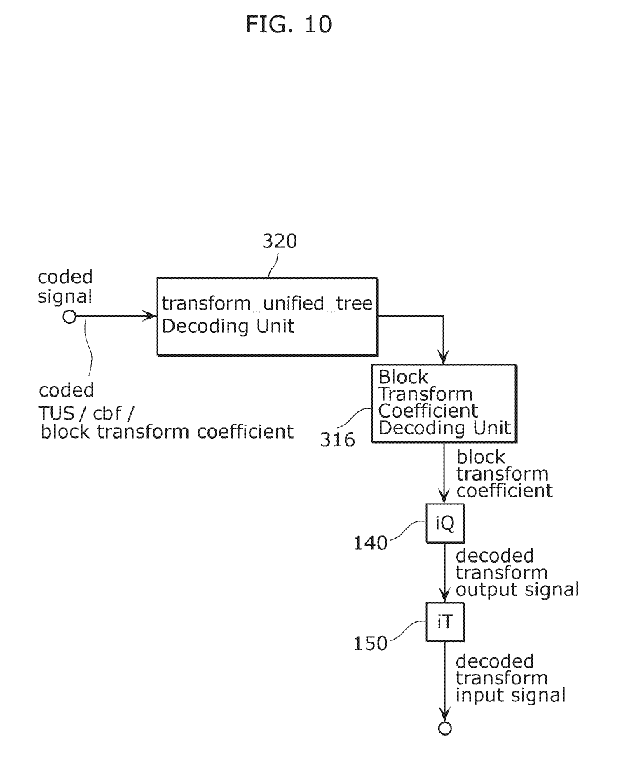

FIG. 10 is a block diagram of an image decoding apparatus according to Embodiment 2. A coded TUS, a coded CBF, and a coded transform coefficient, in other words, coded signals of transform_unified_tree, are provided to the transform_unified_tree decoding unit 320.

According to the TUS tree structure, the transform_unified_tree decoding unit 320 decodes a size and a position of a current transform unit, and decodes the CBF as needed. Then, the transform_unified_tree decoding unit 320 outputs a transform coefficient which is coded for a transform unit having a CBF that is true. The output transform coefficient is applied with entropy decoding by the block transform coefficient decoding unit 316. As a result, a decoded transform coefficient is outputted.

The structure shown in FIG. 10 differs from the structure shown in FIG. 7 in that the TUS memory 313 and the CBF memory 314 are not included. In short, the structure of FIG. 10 can reduce memories.

It should be noted that coding of flags such as cbf_chroma, cbf_luma, cbf_cb, and cbf_cr may be eliminated under predetermined conditions. As a result, a data amount can be reduced.

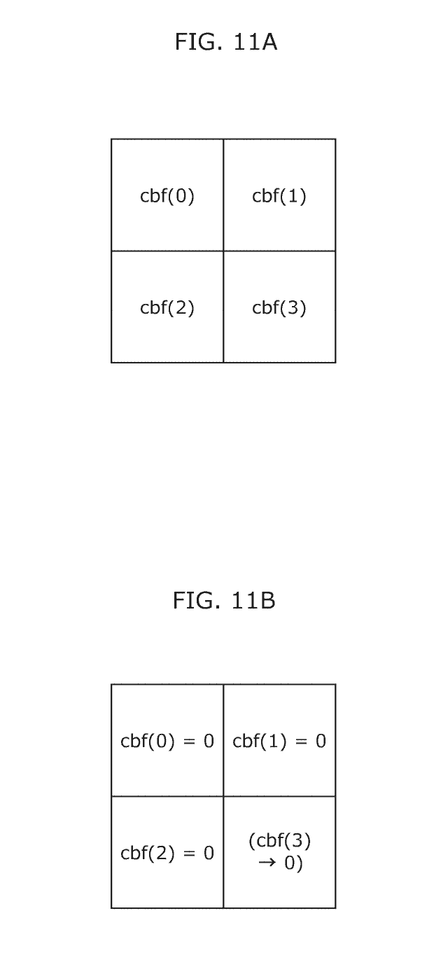

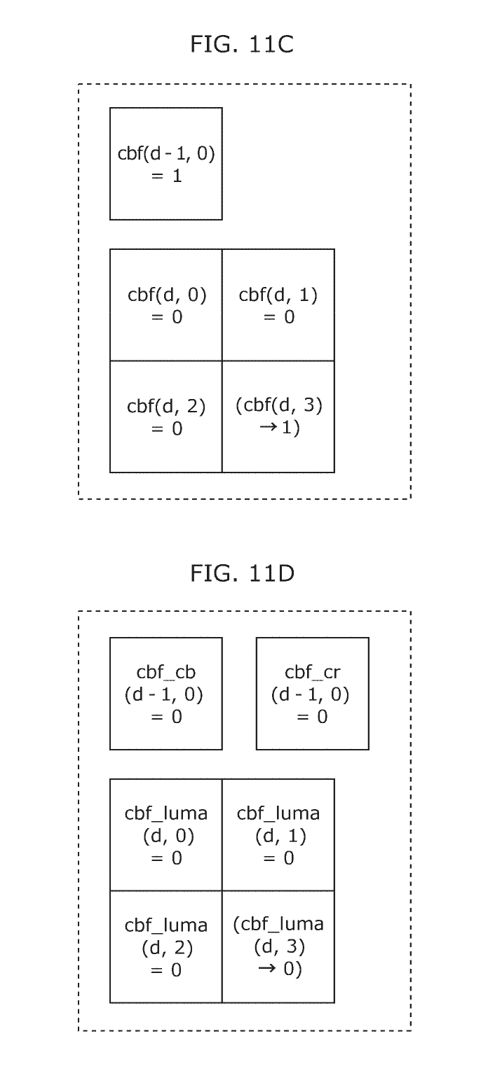

FIG. 11A shows a normal case where a CBF flag is coded for each of four split regions. Next, FIG. 11B shows an example of elimination of coding. If (a) at least one of the four blocks has a transform coefficient and (b) CBFs of blocks at the upper left, at the upper right, and at the lower left are all “0”, then a CBF of a remaining block at the lower right is “1”. In this case, even if the CBF of the block at the lower right is not coded, the CBF of the block at the lower right can be determined. Therefore, coding of the CBF of the block at the lower right can be eliminated.

For another example, FIG. 11C shows CBFs of four blocks at a current transform depth (TrD)=d and a CBF of a block at an upper TrD=d−1. If the CBF of the block at the upper TrD=d−1 is “1”, at least one of the four blocks at the lower TrD=d, to which the block at the upper TrD=d−1 is split, has a transform coefficient. In other words, at least one of the CBFs is “1”.

In this case, in the same manner as shown in FIG. 11B, if the CBFs of blocks at the upper left, at the upper right, and at the lower left at TrD=d are “0”, then the CBF of the block at the lower right is determined as “1”. Therefore, coding of the CBF of the block at the lower right can be eliminated.

In the same manner, FIG. 11D shows an example where cbf_chroma is coded prior to cbf_luma so that cbf_luma depends on cbf_chroma. If (a) cbf_luma of the blocks at the upper left, at the upper right, and at the lower left from among cbf_luma(s) of the four blocks at TrD=d are “0” and (b) cbf_chroma of two blocks at an upper TrD are “0”, then cbf_luma of the block at the lower right is determined as “0”. Therefore, coding of the CBF of the block at the lower right can be eliminated.

As described above, there is a situation where coding of a CBF can be eliminated. In coding CBFs, such elimination under certain conditions may be combined.

In the present embodiment, pieces of information such as a transform unit size, a position, and a transform coefficient are coded in a single tree structure. As a result, it is possible to reduce memories and processing steps.

It should be noted that in the explanation of the flowcharts of FIGS. 8, 9A, and 9B, “code” may be replaced by “decode”. >As a result, flowcharts performed by the image decoding apparatus and the image decoding method can be obtained.

### Embodiment 3

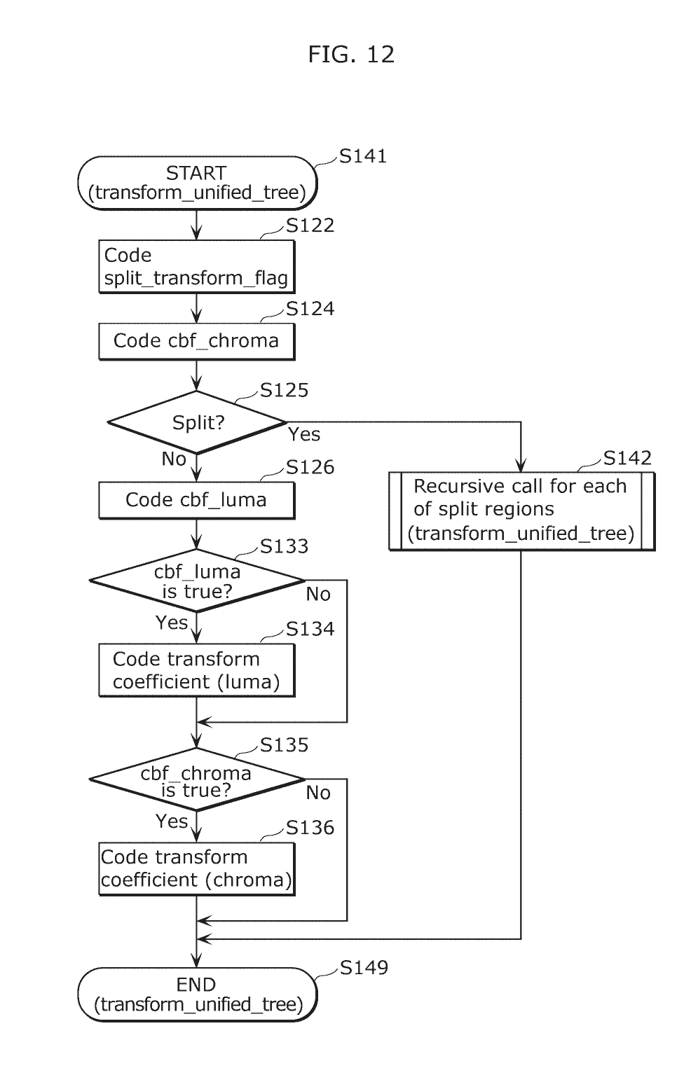

FIG. 12 is a flowchart of a method of coding spit information of a transform unit, a flag (CBF) indicating whether or not there is a transform coefficient, the transform coefficient of the transform unit, and the like according to the present embodiment. The processing for a current transform depth is indicated by transform_unified_tree (S141).

At the current transform depth, a TUS (split_transform_flag) indicating whether or not to split a current block into pieces (S122). Next, the image coding apparatus codes cbf_chroma (S124). Next, the processing is determined according to the TUS (S125).

If the TUS is true, the image coding apparatus spatially splits a current transform unit into further four regions, and recursively calls the transform_unified_tree processing for each of the regions. If the TUS is false, the transform unit is not split. In other words, in this case, the transform unit is a leaf node (the end of the tree structure.

Next, the image coding apparatus codes cbf_luma (S126). Next, only if cbf_luma is true (S133), then the image coding apparatus codes a transform coefficient of luminance signal (S134). Next, only if cbf_chroma is true (S135), then the image coding apparatus codes a transform coefficient of chrominance signal (S136).

With that, the processing for the end of the tree structure is completed (S149), and the processing proceeds to an upper level (a parent node of the leaf node in the tree structure) of a recursive call. When transform sizes, CBFs, and the like have been coded for all of the regions in the current CU, the transform_unified_tree processing is completed.

As chrominance signal is unlikely to have a transform coefficient, it is more efficient to code a CBF corresponding to chroma prior to the block splitting (S125) than after the block splitting. The CBF coding after splitting may be eliminated. As a result, a data amount of the CBF can be reduced.

It should be noted that in the explanation of the flowchart of FIG. 12, if “code” is replaced by “decode”, a flowchart performed by the image decoding apparatus and the image decoding method can be obtained.

### Embodiment 4

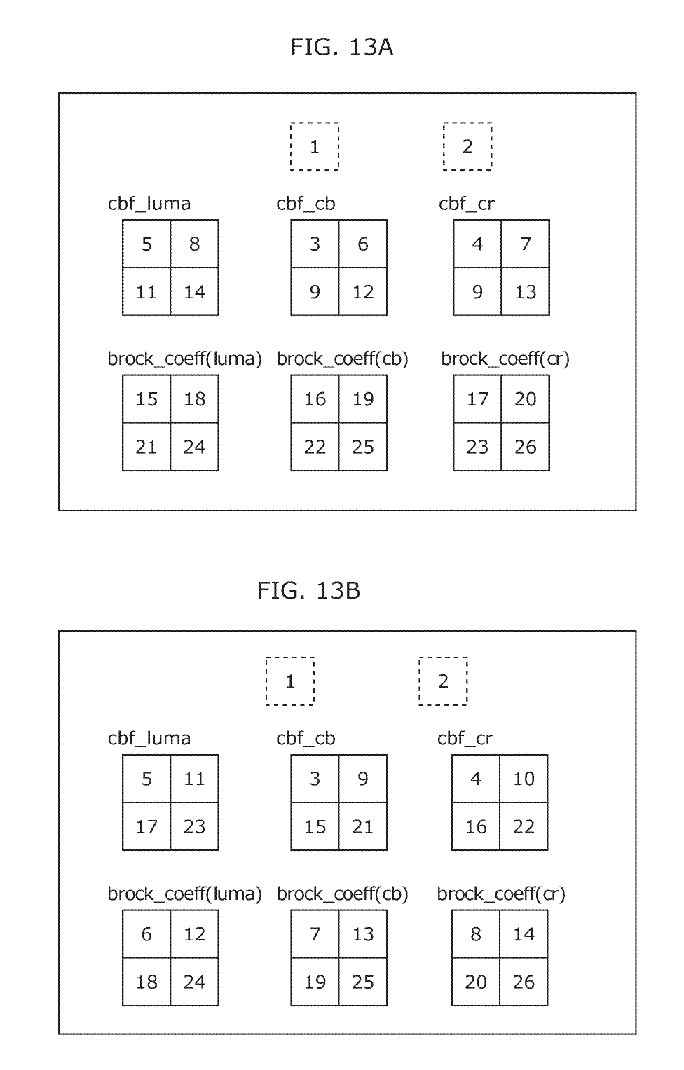

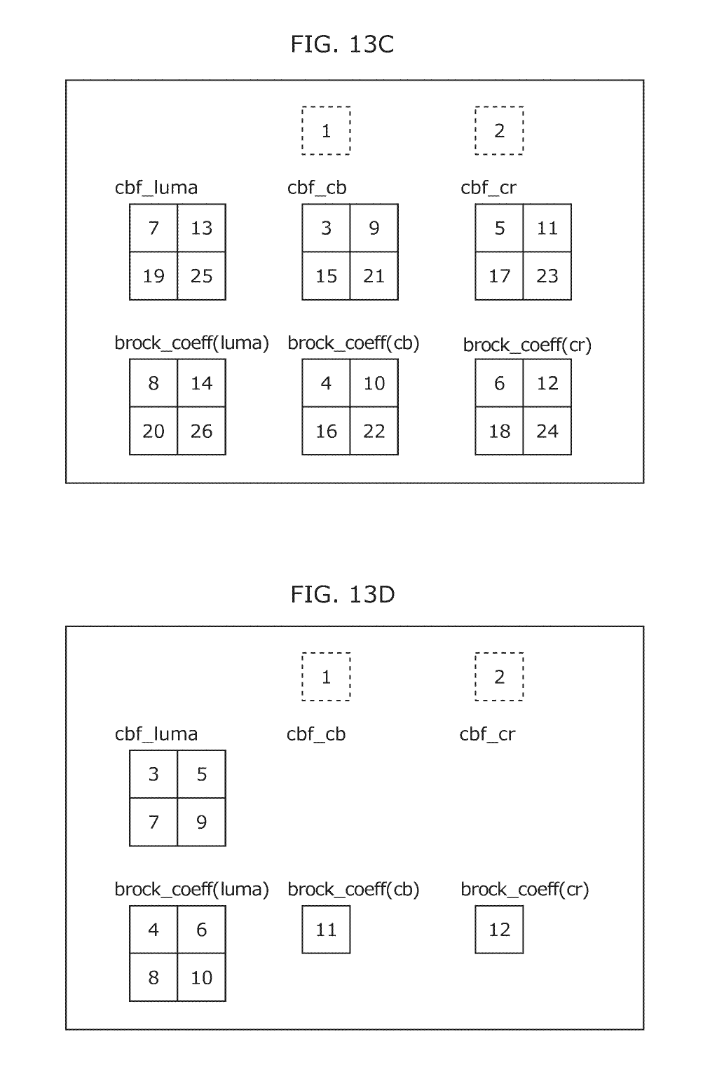

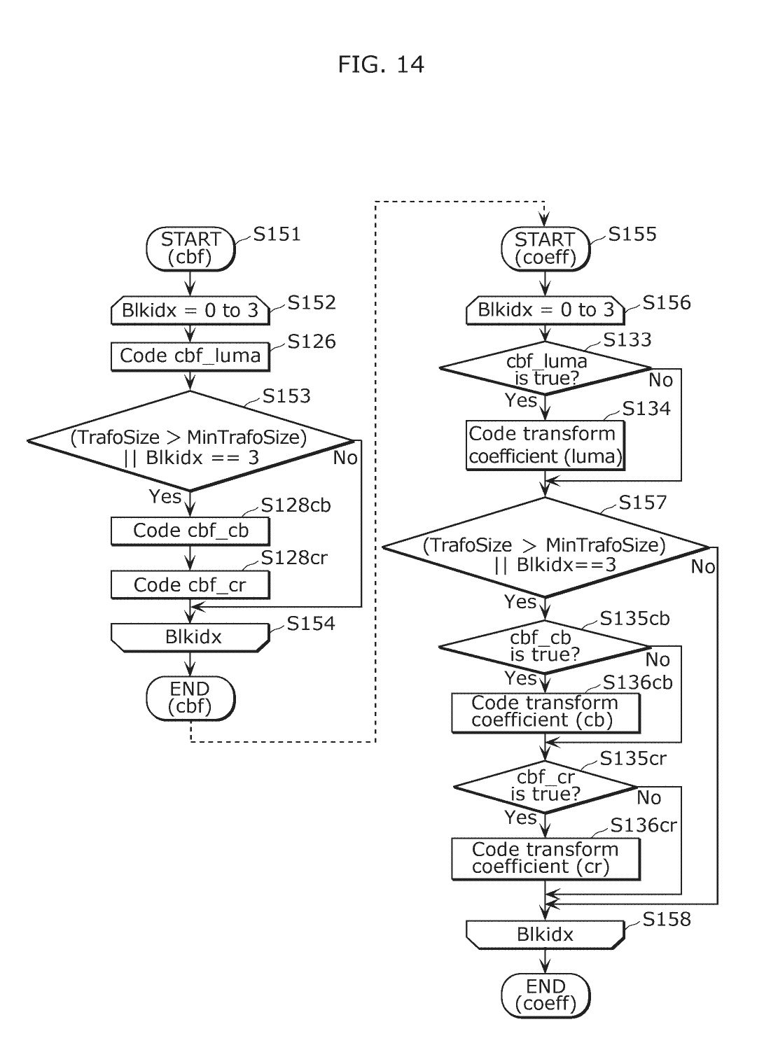

FIG. 13A is a diagram showing an order of coding CBFs and transform coefficients at a current TrD. The numeric values in FIG. 13A represent the coding order. FIG. 13A shows an example where the number of transform blocks of luminance is equal to the number of transform blocks of chroma. The example of FIG. 13A corresponds to the example described in Embodiment 1. A unit including four squares shown by a solid line is split into four regions according to a TUS. The image coding apparatus codes CBFs of chrominance signal prior the splitting. Therefore, each of the CBFs prior to the splitting is shown as a single square shown by a broken line.

At an upper level (TrD−1), the image coding apparatus codes the CBFs of chrominance signal. Therefore, the image coding apparatus first codes cbf_cb (TrD−1, Blk=0) and cbf_cr (TrD−1, Blk=0). Subsequently, for blocks at the upper left at the current TrD, the image coding apparatus sequentially codes cbf_cb (TrD, Blk=0), cbf_cr (TrD, Blk=0), cbf_luma (TrD, Blk=0) in order. Subsequently, the image coding apparatus codes CBFs of the blocks at the upper right, the upper left, and the upper right.

More specifically, the image coding apparatus sequentially codes cbf_cb (TrD, Blk=1), cbf_cr (TrD, Blk=1), cbf_luma (TrD, Blk=1), cbf_cb (TrD, Blk=2), cbf_cr (TrD, Blk=2), cbf_luma (TrD, Blk=2), cbf_cb (TrD, Blk=3), cbf_cr (TrD, Blk=3), and cbf_luma (TrD, Blk=3) in order.

The above numeric values of Blk represent spatial positions of the respective blocks and are determined in Z order. The block at the upper left is Blk=0, the block at the upper right is Blk=1, the block at the lower left is Blk=2, and the block at the lower right is Blk=3. Subsequent to coding all of the CBFs, transform coefficients (block_coeff) are coded.

More specifically, the image coding apparatus sequentially codes block_coeff (luma, Blk=0), block_coeff (cb, Blk=0), block_coeff (cr, Blk=0), block_coeff (luma, Blk=1), block_coeff (cb, Blk=1), block_coeff (cr, Blk=1), . . . , block_coeff (cr, Blk=3) in order.

The image coding apparatus codes transform coefficients of luminance signal prior to transform coefficients of chrominance signal. This is because prediction modes include a mode (LM mode) in which a prediction parameter is generated based on a decoded result of luminance signal to predict chrominance signal. By coding transform coefficients of luminance signal prior to transform coefficients of chrominance signal, an order of coding transform coefficients matches an order of processing in the LM mode. Therefore, it is possible to eliminate an additional memory for exchanging the orders.

It should be noted that an order is the same at any recursive levels (TrD). Therefore, in the above description, details of recursive levels of the transform coefficients are not given.

FIG. 13B is a diagram of a coding order in the case where the number of transform blocks of luminance signal is equal to the number of transform blocks of chrominance signal. FIG. 13B corresponds to an example of or after Embodiment 2. Since CBFs and transform coefficients are coded in the same tree structure, a transform coefficient corresponding to a currently-coded CBF is coded relatively soon.

For example, after coding cbf_luma (Blk=0), cbf_cb (Blk=0), and cbf_cr (Blk=0), the image decoding apparatus codes block_coeff (luma, Blk=0), block_coeff (cb, Blk=0), and block_coeff (cr, Blk=0) which correspond to the respective three blocks. This means that the image decoding apparatus can reduce a memory size for temporarily storing CBFs.

In the example of FIG. 13A, the image coding apparatus cannot store transform coefficients as a stream until CBFs of all blocks are specified. Therefore, it would be necessary to have a large-size memory for storing transform coefficients of transform units processed in an earlier part of a current CU. Such a problem is solved by the example of FIG. 13B.

FIG. 13C is a diagram of a coding order in the case where the number of transform blocks of luminance signal is equal to the number of transform blocks of chrominance signal. In FIG. 13C, a transform coefficient is coded immediately after coding a corresponding CBF. In this example, a size of a temporal memory for CBFs or transform coefficients may be smaller than the example in FIG. 13B.

More specifically, the image coding apparatus sequentially codes cbf_cb (TrD, Blk=0), block_coeff (cb, Blk=0), cbf_cr (TrD, Blk=0), block_coeff (cr, Blk=0), cbf_luma (TrD, Blk=0), block_coeff (luma, Blk=0), . . . , block_coeff (luma, Blk=3) in order.

FIG. 13D is a diagram of a coding order in the case where the number of transform blocks of chrominance signal is less than the number of transform blocks of luminance signal. For example, at a 4:2:0 format, the number of pixels of chrominance signal is a half of the number of pixels of luminance signal, in a view of a horizontal or vertical line of pixels. For the orthogonal transforming unit and the inverse orthogonal transforming unit, a minimum size is restricted to a certain size. Therefore, if a transform unit is a minimum size (a transform size is MinTrafoSize), four transform units of luminance signal would correspond to a single transform unit of chrominance signal.

FIG. 13D shows the coding order under the above-described situation. First, the image coding apparatus codes CBFs of chrominance signal (chrominance values) at an upper level, and then codes the four blocks of luminance signal (luminance values) in Z order. Here, the image coding apparatus codes a transform coefficient after coding a corresponding CBF for each of the four blocks. Finally, the image coding apparatus codes a transform coefficient of one block of chrominance signal.

The coding order has advantages that the short interval between coding a CBF and coding a transform coefficient for luminance signal allows the temporal memory to have a reduced size. For chrominance signal, an interval between coding a CBF and coding a transform coefficient is slightly longer. However, there is a possibility that a data amount of chrominance signal is less than a data amount of luminance signal. Therefore, chrominance signal is expected to less influential. The coding order in FIG. 13D is also effective when chrominance signal is predicted by using luminance signal, like the ML mode.

FIG. 14 is a flowchart of a method of coding spit information of a transform unit, a flag (CBF) indicating whether or not there is a transform coefficient, the transform coefficient of the transform unit, and the like according to the present embodiment. The processing for a current transform depth is indicated by transform_unified_tree in FIG. 8 or 12. FIG. 14 shows a part related to a CBF and a transform coefficient in transform_unified_tree.

Coding of a CBF at a current TrD (S151) is performed for each of four split transform units (S152). The four transform units are associated with respective Blkidx(s) sequentially in Z order. First, the image coding apparatus codes cbf_luma (S126). Next, the image coding apparatus determines whether or not to code cbf_chroma (cbf_cb and cbf_cr).

If the number of transform units of luminance signal is equal to the number of transform units of chrominance signal, then the image coding apparatus codes cbf_chroma. Regarding the conditions for the above determination, the determination may also be made according to whether or not a transform size (TrafoSize) of luminance signal at the current TrD is larger than the minimum size (MinTrafoSize) (TrafoSize>MinTrafoSize). The conditions may be any other conditions producing equivalent results.

On the other hand, even if the number of transform units of chrominance signal is less than the number of transform units of luminance signal, the image coding apparatus codes chrominance signal after coding luminance signal. In the case of splitting into four regions, coding of cbf_luma for four transform units is ended at Blkidx=3. Therefore, in the case of Blkidx=3, the image coding apparatus determines to code cbf_chroma. In summary, in the case of (Trafosize>MinTrafoSize)∥(Blkidx==3), the image coding apparatus determines to code chrominance signal after coding luminance signal (S153).

Only when it is determined to code chrominance signal (Yes at S153), the image coding apparatus codes cbf_cb (S128cb), and codes cbf_cr (S128cr). Then, the image coding apparatus performs processing for all of four blocks (S154).

After coding a CBF, some processing may be performed. After that, the image coding apparatus codes a transform coefficient (S155). In the same manner as describe for the case of coding a CBF, the image coding apparatus sequentially processes four blocks (S156). Only if cbf_luma is true (S133), then the image coding apparatus codes a transform coefficient of luminance signal (S134).

Next, the image coding apparatus makes the same determination as S153 to determine whether or not to code a transform coefficient of chrominance signal (S157). Only if the above determination is true (Yes at S157) and cbf_cb is true (Yes at S135cb), then the image coding apparatus codes a transform coefficient of a Cb component of chrominance signal. On the other hand, only if the above determination is true (Yes at S157) and cbf_cr is true (Yes at S135cr), the image coding apparatus codes a transform coefficient of a Cr component of chrominance signal.

In the present embodiment, coding of a CBF is simplified. It should be noted that in the explanation of the flowchart of FIG. 14, if “code” is replaced by “decode”, a flowchart performed by the image decoding apparatus and the image decoding method can be obtained. It should also be noted that in the explanation of the coding order of FIGS. 13A, 13B, 13C, and 13D, if “code” is replaced by “decode”, a decoding order can be obtained. Each of the coding order and the decoding order corresponds to an arrangement order of coded data.

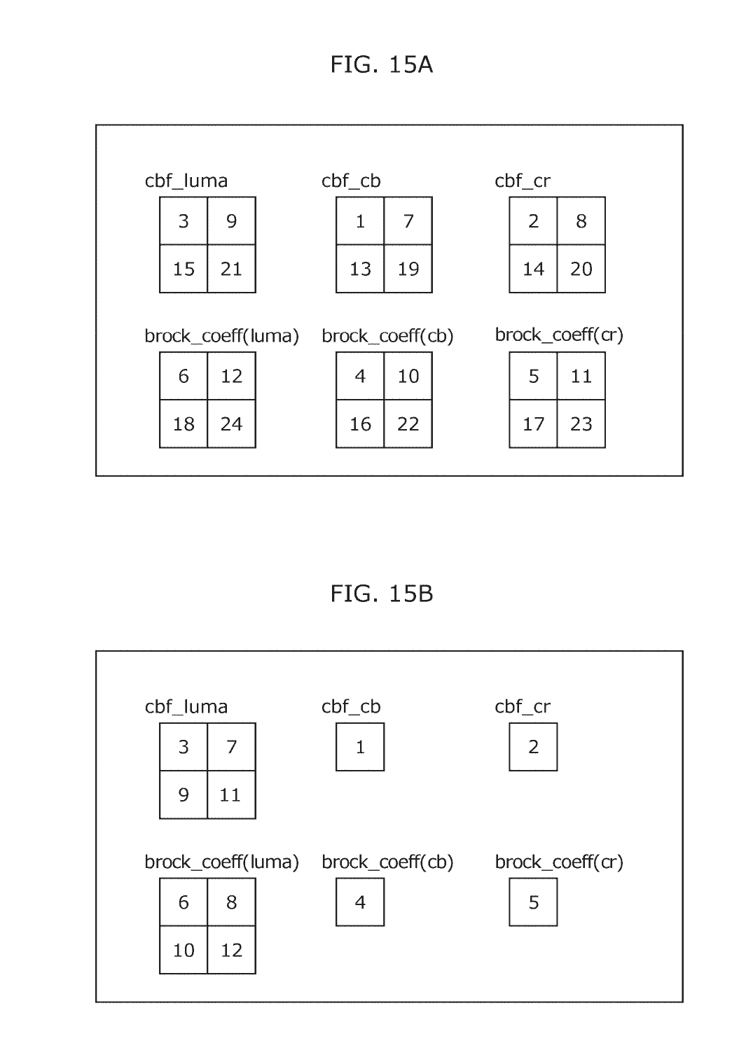

Each of FIGS. 15A and 15B shows an example where CBFs and transform coefficients of chrominance signal are coded prior to those of luminance signal. In the same manner as eliminating coding of a CBF, in inter prediction, there is a situation where chroma_cbf is coded prior to luma_cbf. The order shown in FIGS. 15A and 15B matches the order in the above case. Therefore, the processing performed by the image coding apparatus and the processing performed by the image decoding apparatus are simplified.

### Embodiment 5

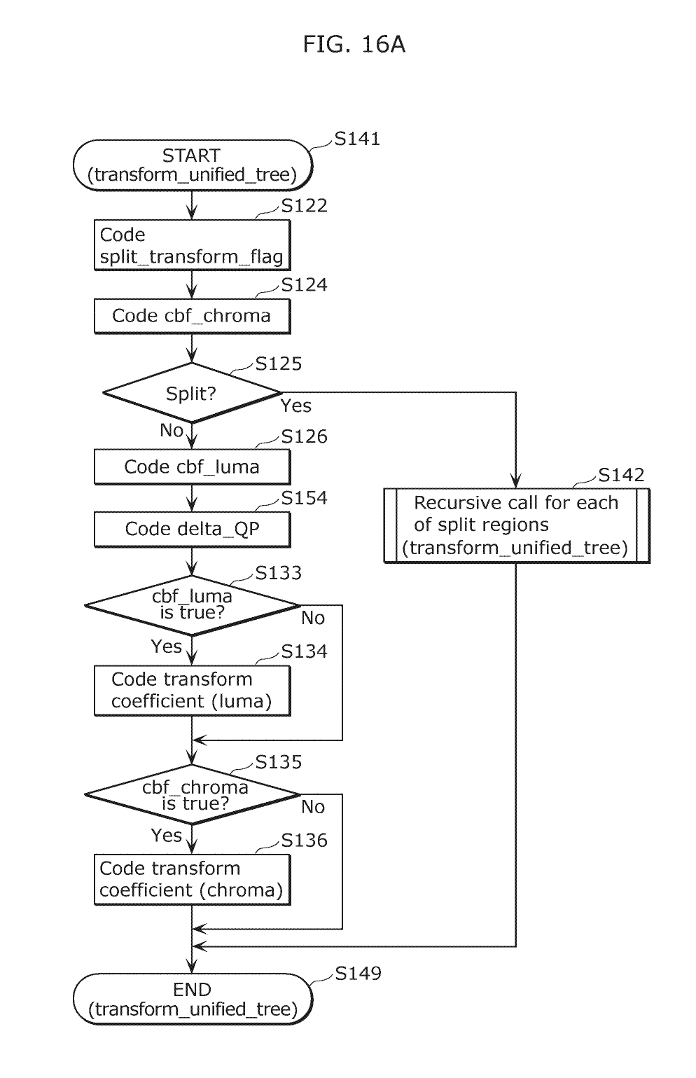

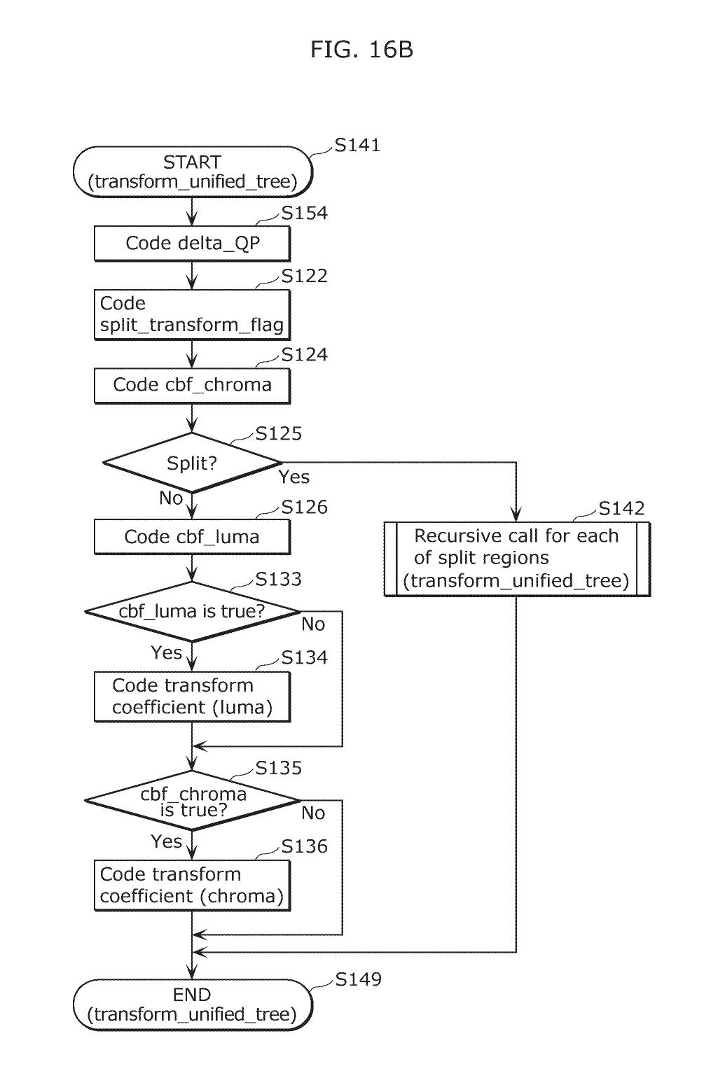

FIG. 16A shows a flowchart of coding delta_QP that is a difference quantization parameter. The flowchart of FIG. 16A is almost the same as the flowchart of FIG. 12. The following describes differences between them only.

The image coding apparatus codes delta_QP after coding all CBFs. More specifically, the image coding apparatus codes delta_QP (S154) between coding of cbf_chroma and cbf_luma (S124 and S126) and coding of transform coefficients (S134 and S136).

For example, the image decoding apparatus may perform inverse quantization using pipeline processing immediately after decoding a transform coefficient. In this case, it is reasonable to code delta_QP, which is used to determine a quantization parameter, in the above-described coding order, so that unnecessary delay and memory increase can be prevented.

It should be noted that delta_QP may be coded only for a transform unit having the first true cbf_luma or cbf_chroma from among a plurality of transform units included in a CU. This is because a coding amount is increased too much if delta_QP coding is performed more than that. By decreasing the frequencies of coding delta_QP, the coding amount is reduced.

FIG. 16B shows an example where delta_QP is coded at the beginning of transform_tree. In this case, the image decoding apparatus can early determine a quantization parameter used in the inverse quantization unit, which allows the inverse quantization unit to start early. The delta_QP is not necessarily coded always. For example, it is also possible that, for a current CU, delta_QP is coded only if no_residual_data is true. As a result, a data amount is reduced.

Here, no_residual_data is a flag indicating that there is no transform coefficient in a current CU. no_residual_data is coded prior to the first split_transform_flag in the CU.

It should be noted that in the explanation of the flowcharts of FIGS. 16A and 16B, if “code” is replaced by “decode”, flowcharts performed by the image decoding apparatus and the image decoding method can be obtained.

### Embodiment 6

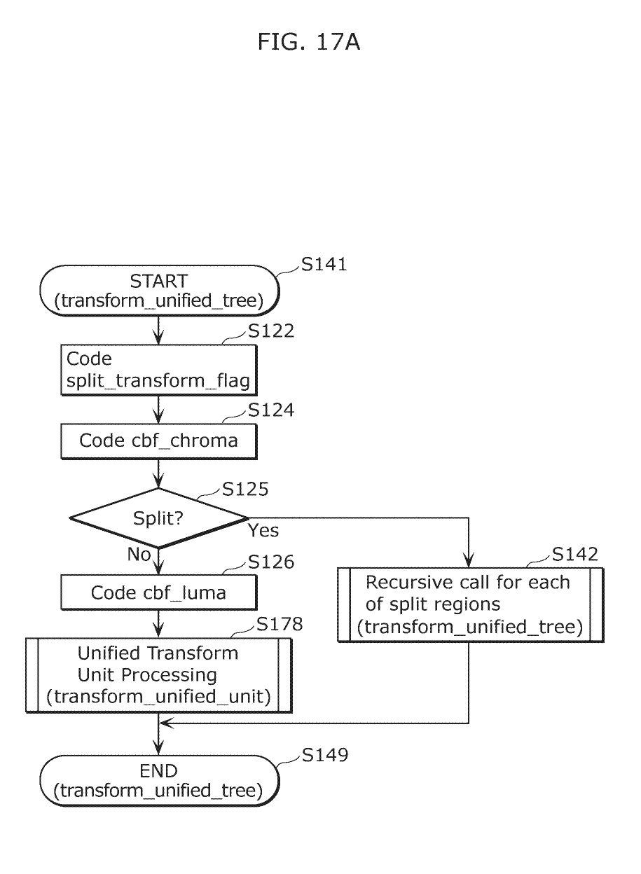

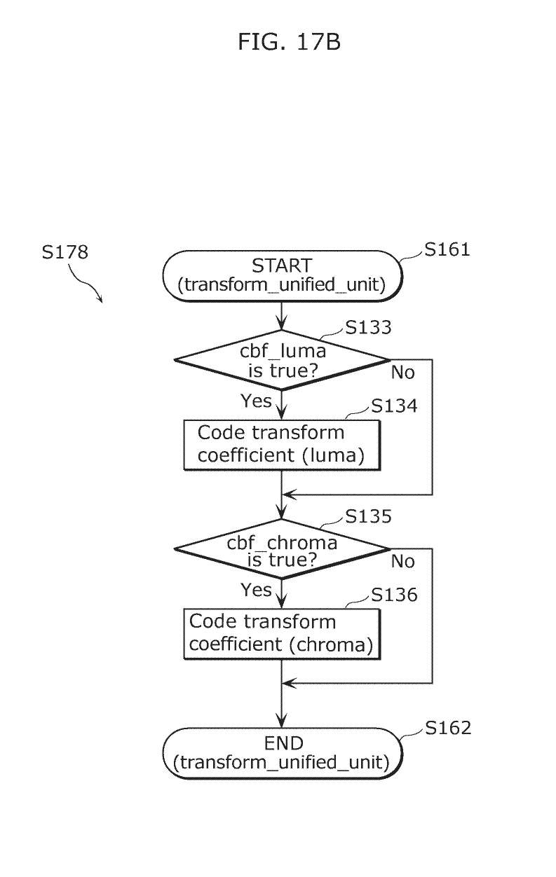

Each of FIGS. 17A and 17B is a flowchart of a method of coding spit information of a transform unit, a flag (CBF) indicating whether or not there is a transform coefficient, the transform coefficient of the transform unit, and the like according to the present embodiment. In FIG. 17A, the processing at a current transform depth (recursive level) is indicated as transform_unified_tree (S141).

The present embodiment differs from the above-described embodiments mainly in that the steps (S133, S134, S135, and S136) for coding a transform coefficient is extracted as a sub routine (united transform unit processing: transform_unified_unit). The sub routine shown in FIG. 17B is called from a main routine shown in FIG. 17A (S178).

In this case, also in the same manner as described for the above embodiments, it is possible to decrease a size of a memory for temporarily holding CBFs and TUSs, simplify the steps, and decrease the number of traverses, for example. That is, the substantially same effects as described above can be produced.

It should be noted that the step S126 may be moved to transform_unified_unit. In other words, all of the steps for a leaf node in the tree structure may be defined by the sub routine. Furthermore, delta_QP may be coded in transform_unified_unit. The use of sub routine makes it possible to produce the substantially same effects. In addition, the separation of a sub routine from processing makes it possible to save work for design and decrease the number of tests, for example.

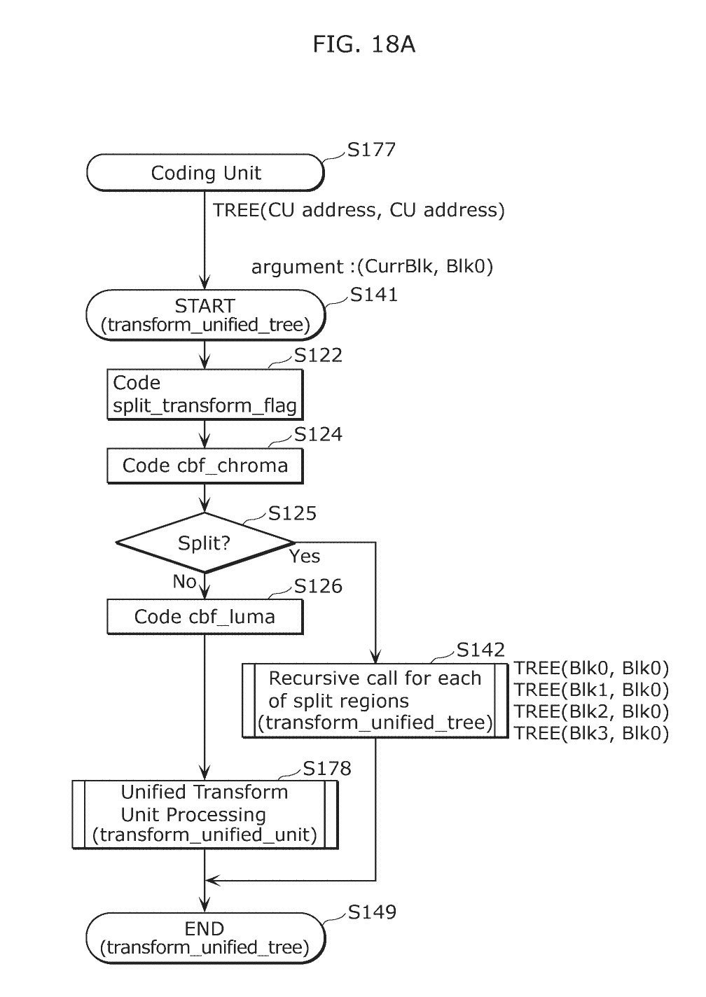

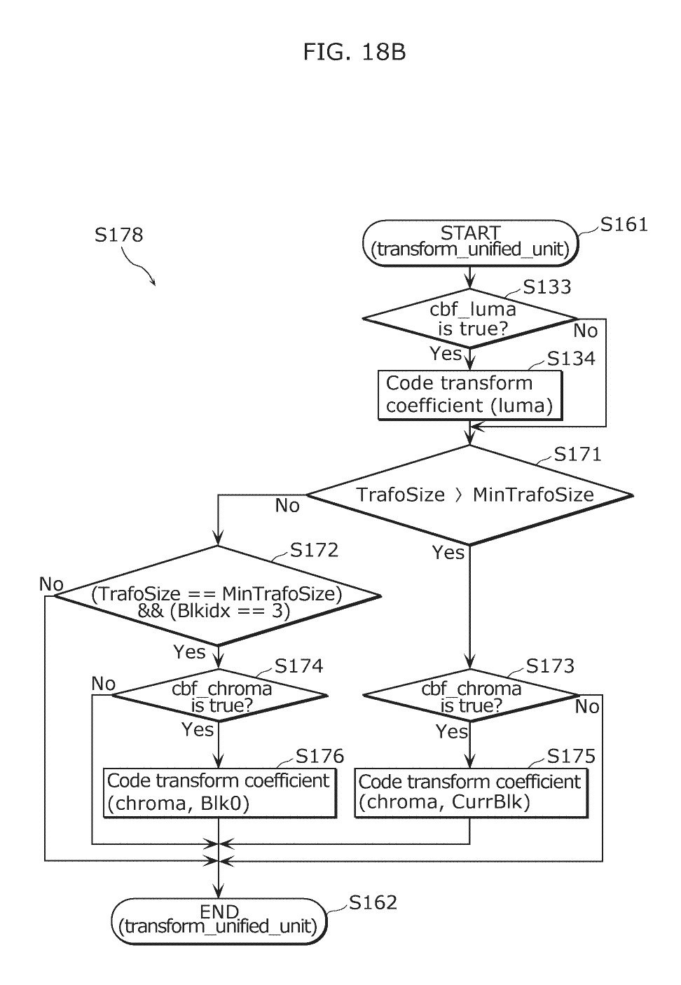

Each of FIGS. 18A and 18B is a flowchart of coding spit information, a CBF, and a transform coefficient. Furthermore, each of FIGS. 18A and 18B shows pieces of information indicating spatial positions of image blocks. Such pieces of information indicating spatial positions of image blocks are used to specify current pieces of data to be processed in pipeline processing. Therefore, as shown in FIG. 18A, position information is assigned to an argument in the processing.

In particular, when the recursive level (TransformDepth) reaches a predetermined recursive level (MinTrafoDepth), there is a possibility that a transform coefficient of a block of chrominance signal is outputted once for four times. Moreover, there is a possibility that a spatial position of a block (in other words, a current block) to be used to code a transform coefficient of chrominance signal is indicated not as a position of a block generated by splitting a block into four pieces (in other words, the current block), but a position of the block that has not yet been split into four pieces (in other words, a block from which the current block is split). Therefore, each of transform_unified_tree and transform_unified_unit are provided with pieces of information of two positions.

More specifically, the first position of such two positions is a position of a current block from among four blocks generated by splitting a block into four pieces. The second position is a position of the first block in Z order from among the four blocks. Here, the position of the block is at the upper left of the block. Therefore, the second position is the same as the position of the block that has not yet been split into four pieces.

In the following, CurrBlk represents a position of a current block. Blk0 represents a position of the first block from among the four split blocks, Blk1 represents a position of the second block from among the four split blocks, Blk2 represents a position of the third block from among the four split blocks, and Blk3 represents a position of the fourth block from among the four split blocks. Blk0 is the same as the position of the block from which the above four blocks are split.

First, transform_unified_tree is called from processing of a current CU. Here, an initial value of each of two positions assigned as arguments to transform_unified_tree is the position of the CU. In other words, by using CurrBlk=CU and Blk0=CU as arguments, transform_unified_tree is called.

The processing related to a CBF is not different from the processing as described above, it is not described here. If splitting is not performed (No at S125), then CurrBlk and Blk0 are provided as arguments to transform_unified_unit (S178).

On the other hand, if splitting is performed (Yes at S125), then the image coding apparatus recursively calls transform_unified_tree for each of four blocks generated by splitting the current block into four pieces. Here, the image coding apparatus calls transform_unified_tree using the pieces of information of two positions as arguments.

The first position included in the arguments includes positions (Blk0, Blk1, Blk2, and Blk3) of the four split blocks. The first position is sequentially changed in four recursive calls. The second position is a position (Blk0) of the first block from among the four split blocks. The second position is not changed during the four recursive calls, and is always the position of the first block.

Likewise, transform_unified_tree_unit also receives pieces of information of two positions. The first position is a position (CurrBlk) of a current block, and the second position is a position (Blk0) of the first block from among four split blocks including the current block (S161).

Only if cbf_luma is true (S133), then the image coding apparatus codes a transform coefficient of luminance signal of the current block (S134).

Next, the image coding apparatus determines whether or not a transform size of luminance signal of the current block (TrafoSize) is larger than a minimum transform size of luminance signal (MinTrafoSize) (S171). In other words, the image coding apparatus determines whether or not transform of chrominance signal is performed on a single current block.

Here, for example, it is possible to previously define a minimum transform size of chrominance signal (MinChromaTrafoSize). Then, the image coding apparatus may calculate a transform size of chrominance signal of a current block (ChromaTrafoSize), and compare the calculated transform size to the previously defined minimum transform size. In any cases, if a current block is a unit used in transform of chrominance signal and also a unit used in transform of luminance signal, the determination at S171 is made as true.

Next, if a CBF corresponding to chrominance signal of the current block is true (S173), then the image processing apparatus codes a transform coefficient of chrominance signal of the current block. Here, the image processing apparatus uses the position (CurrBlk) of the current block.

On the other hand, if the transform size of luminance signal of the current block (TrafoSize) is not larger than the minimum transform size of luminance signal (MinTrafoSize) (No at S171), then the four blocks of luminance signal correspond to a single block of chrominance signal. In this case, the image coding apparatus codes a transform coefficient of the single block of chrominance signal after coding transform coefficients of the four blocks of luminance signal. Therefore, the image coding apparatus determines whether or not the current block is a last block (the fourth block) (S172).

If the determination result is true (Yes at S172), then the image coding apparatus determines whether or not a CBF of chrominance signal of the current block is true (S174). If it is true (Yes at S174), then the image coding apparatus codes a transform coefficient of chrominance signal (S176). Here, the image coding apparatus codes a transform coefficient of chrominance signal of a block from which the current block is split. Therefore, the image coding apparatus uses the position (Blk0) of the first block, not the position (CurrBlk) of the current block.

It should be noted that in the explanation of the flowcharts of FIGS. 17A, 17B, 18A, and 18B, if “code” is replaced by “decode”, flowcharts performed by the image decoding apparatus and the image decoding method can be obtained.

In the present embodiment, pieces of information of two positions, which are (a) a position of a block from which a current block is split and (a) a position of the current block generated by splitting the above block into four pieces, are used as arguments in each of transform_unified_tree and transform_unified_unit. Then, based on whether or not the current block has a minimum size (MinTrafoSize), the two positions are switched. As a result, it is possible to appropriately manage a position of a pixel to be transformed.

For example, if two positions are not assigned as arguments, a position of a block from which four blocks are split can be calculated using a position of a current block of the four split blocks. However, in this case, a calculation amount is increased. In the present embodiment, since two positions are assigned as arguments, the calculation amount increase can be prevented.

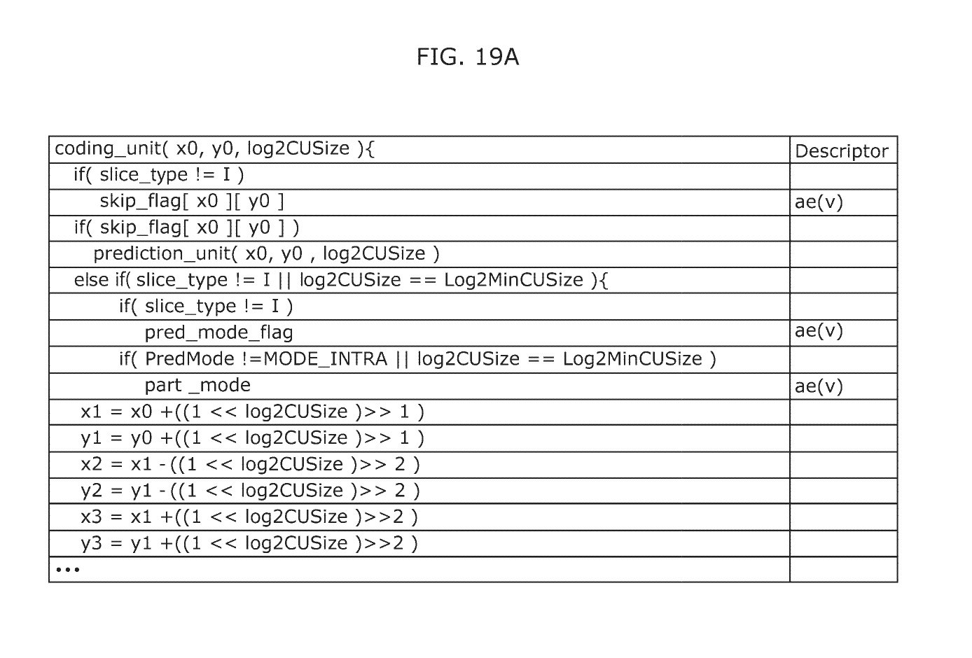

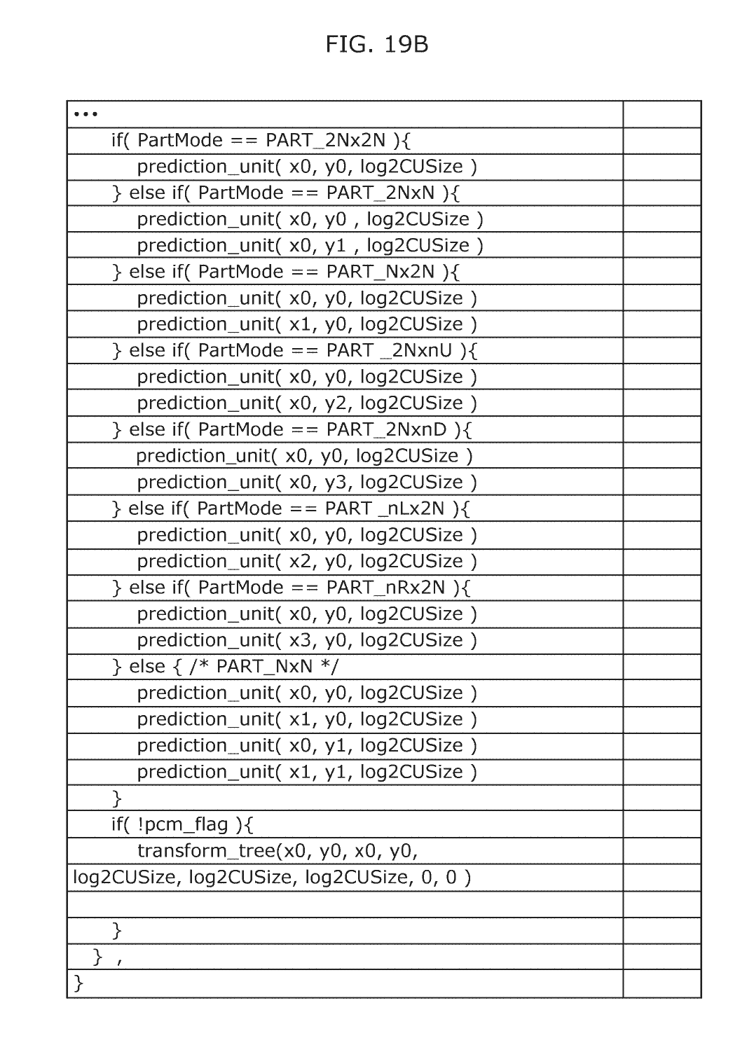

It should be noted that FIGS. 19A, 19B, 20A, 20B, 20C, and 21 are syntaxes relating to the image decoding apparatus. In particular, pieces of information of two positions relating to the present embodiment are underlined. Arguments x0 and y0 correspond to a position (CurrBlk) of the current block, and arguments xC and yC correspond to a position (Blk0) of the first block.

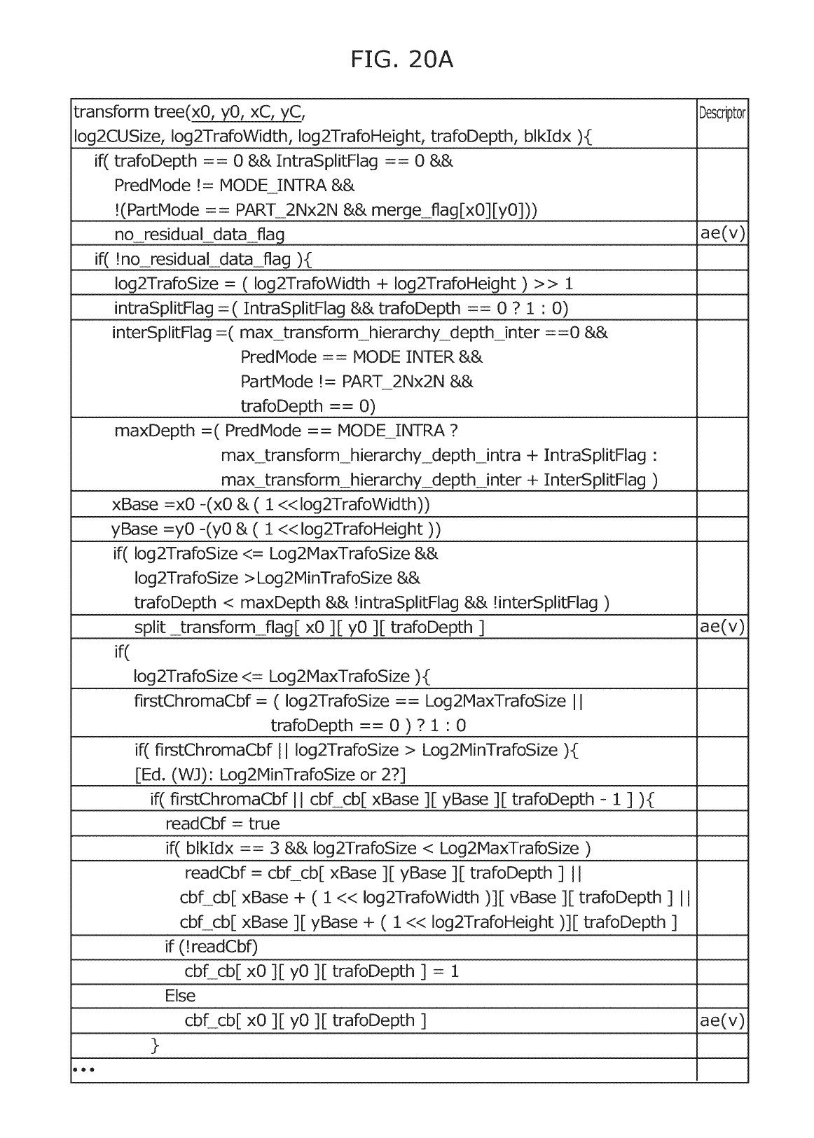

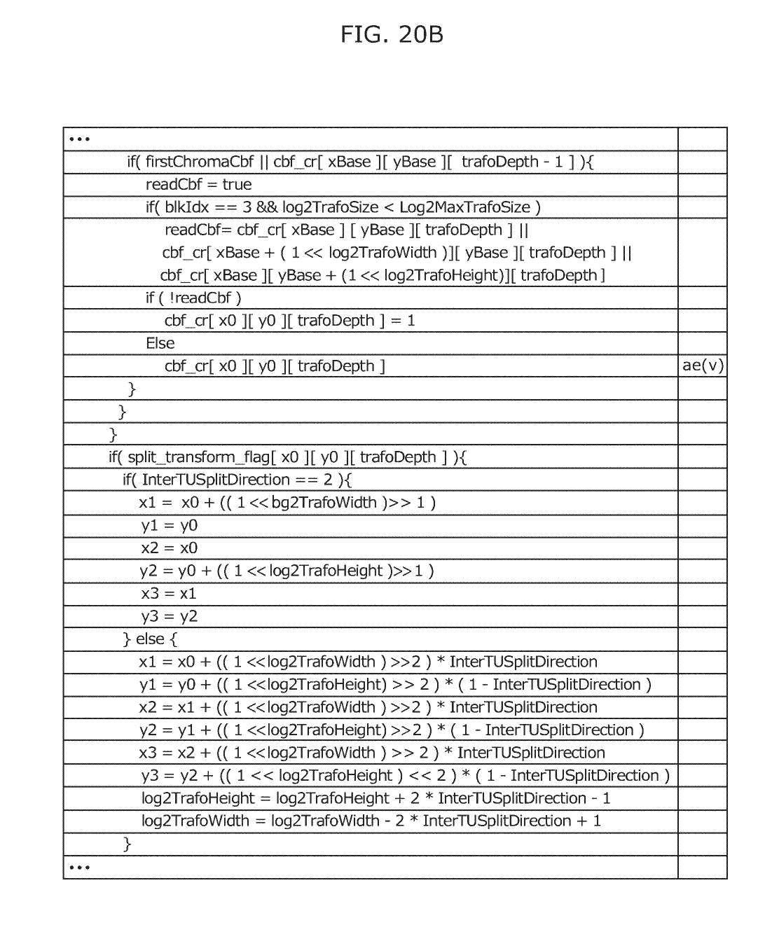

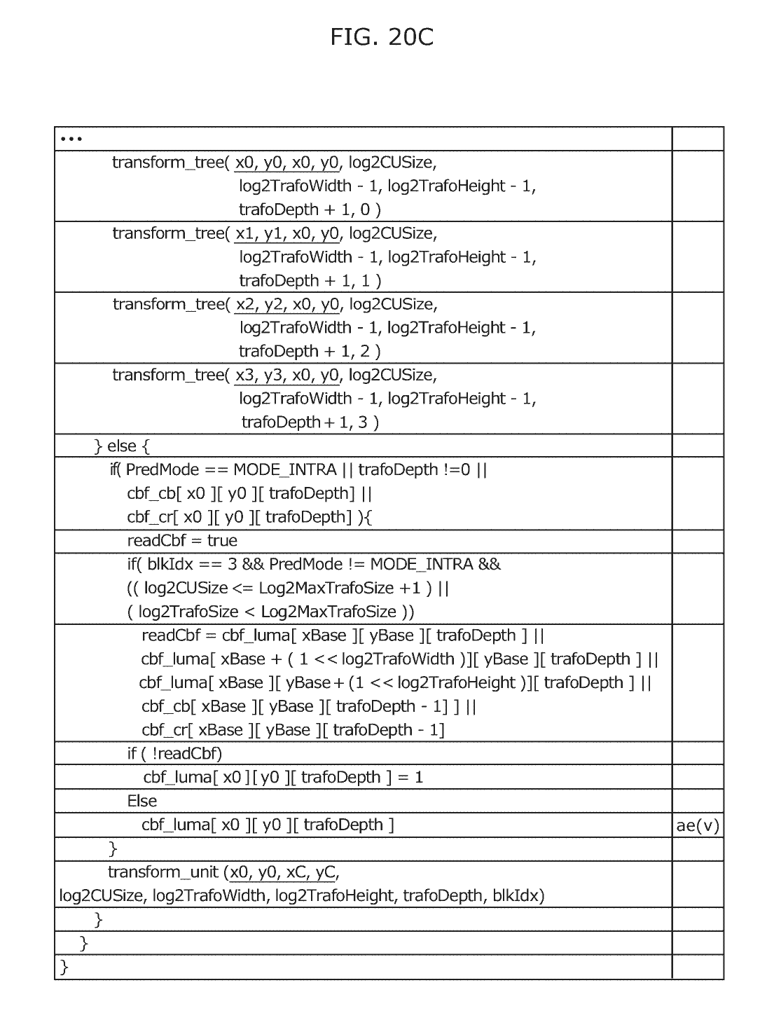

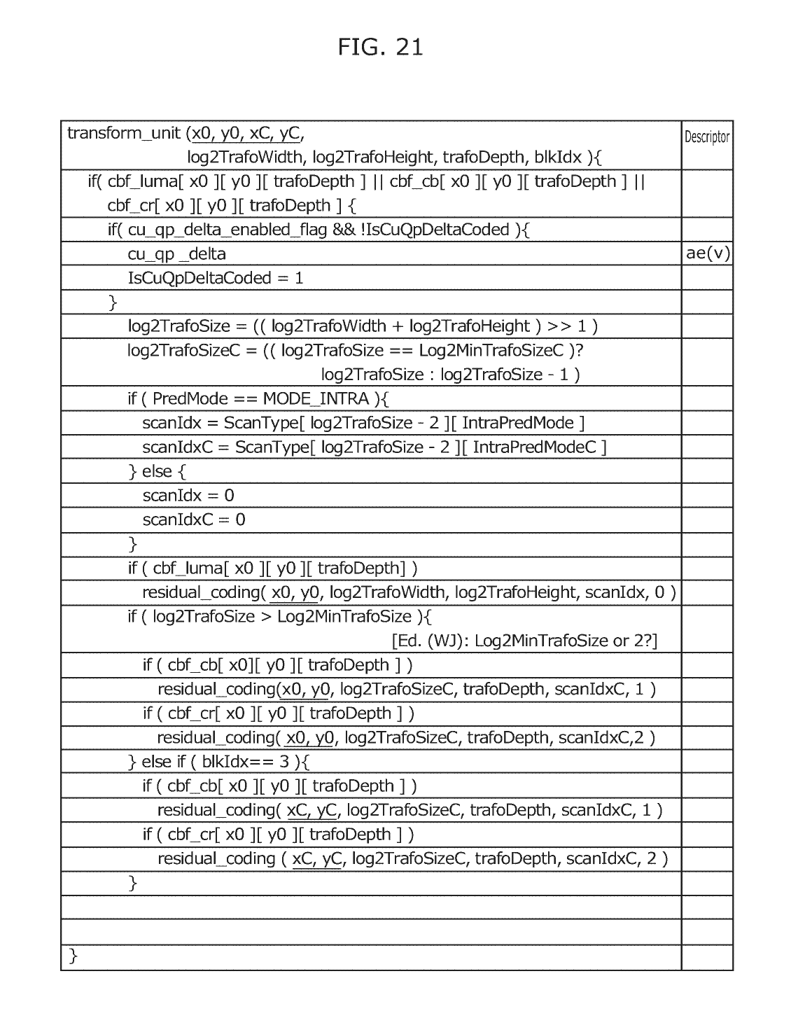

The syntax (coding_unit) in each of FIGS. 19A and 19B correspond to the processing for a current CU. The syntax (transform_tree) in FIGS. 20A, 20B, and 20C correspond to transform_unified_tree. The syntax (transform_unit) in FIG. 21 corresponds to transform_unified_unit.

### Embodiment 7

In the present embodiment, the characteristic structures and steps described in the above embodiments are described for confirmation.

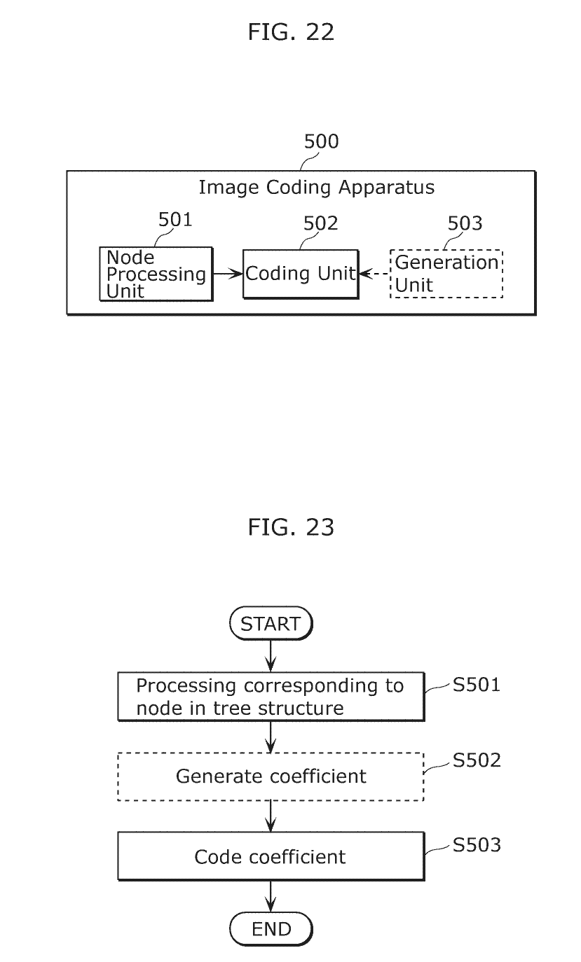

FIG. 22 shows an image coding apparatus according to the present embodiment. As shown in FIG. 22, an image coding apparatus 500 includes a node processing unit 501 and a coding processing unit 502. The image coding apparatus 500 may further include a generation unit 503. It is also possible that the generation unit 503 is not included in the image coding apparatus 500.

For example, the node processing unit 501 corresponds to the entropy coding unit 190, the transform_unified_tree decoding unit 320 that can be read also as the transform_unified_tree coding unit, and the like which are described in the above embodiments. The coding processing unit 502 corresponds to the entropy coding unit 190 and the block transform coefficient decoding unit 316 hat can be read also as the block transform coefficient coding unit. The generation unit 503 corresponds to the prediction unit 180, the subtractor 110, the transforming unit 120, the quantization unit 130, and the like.

The following describes each of the structural elements included in the image coding apparatus 500 in more detail. First, the node processing unit 501 performs node processing on each of nodes in the tree structure. The tree structure has a plurality of nodes each corresponding to a corresponding one of image blocks. The tree structure has a relationship in which each of the image blocks generated by splitting an image block corresponding to a parent node corresponds to a child node of the parent node. More specifically, for example, the tree structure has a root node corresponding to a CU of image, and leaf nodes each corresponding to a corresponding one of transform units that is a luminance value in the CU.

Furthermore, in node processing, recursive call of the node processing or call of coding processing is performed according to a node. The node processing corresponds to transform_unified_tree, transform_tree, and the like which are described in the above embodiments. The coding processing corresponds to transform_unified_unit, transform_unit, and the like.

For example, if node processing is performed on a parent node having child nodes, the node processing unit 501 recursively calls node processing. Here, the node processing unit 501 assigns (a) a position of an image block corresponding to a current child node and (b) a position of an image block corresponding to the parent node, to arguments of node processing, and recursively calls the node processing for the child node.

If node processing is performed on a leaf node, the node processing unit 501 assigns (a) a position of an image block corresponding to the leaf node and (b) a position of an image block corresponding to a parent node of the leaf node, to arguments of coding processing, and calls coding processing.

If the node processing is performed for a leaf node by recursively calling node processing, the node processing unit 501 can assign a position which is assigned to the argument of the node processing, to an argument of coding processing. Therefore, the node processing unit 501 does not need to calculate the position of the image block corresponding to the parent node of the leaf node from the position of the image block corresponding to the leaf node.

The coding processing unit 502 performs coding processing for coding a frequency coefficient of an image block. In the coding processing, an image block corresponding to a leaf node or a frequency coefficient of an image block corresponding to a parent node of the leaf node is coded. These image blocks can be specified by positions assigned to arguments in the coding processing.

For example, in coding processing, if the following two conditions are satisfied, a frequency coefficient of a chrominance value of an image block corresponding to a parent node is coded. The two conditions are (a) that an image block corresponding to a leaf node has a predetermined minimum size and (b) that the number of pieces of data of chrominance values of an image block corresponding to a leaf node is less than the number of pieces of data of luminance values. The above-described conditions are an example, and any other conditions resulting the same may be used.

The generation unit 503 performs frequency transform and quantization on a prediction error between (a) (a1) a pixel value of an image block corresponding to a leaf node or (a2) a pixel value of an image block corresponding to a parent node of the leaf node and (b) a prediction pixel value, thereby generating a frequency coefficient. For example, in coding processing, the frequency coefficient generated by the generation unit 503 is coded.

FIG. 23 shows the processing performed by the image coding apparatus 500 shown in FIG. 22. First, the node processing unit 501 performs node processing on a node in the tree structure (S501). If node processing is performed on a parent node, node processing is recursively called for a child node. If node processing is performed for a leaf node, coding processing is called. On the other hand, the generation unit 503 generates a frequency coefficient (S502). After that, the coding processing unit 502 performs coding processing for coding the frequency coefficient (S503).

The frequency coefficient may be generated by a different apparatus or by a different method. Therefore, the generation of frequency coefficient (S502) may be eliminated from the present embodiment.

As described above, the image coding apparatus 500 uses, as arguments, both (a) a position of an image block corresponding to a child node and (b) a position of an image block corresponding to a parent node. As a result, a calculation amount for calculating positions of image blocks is reduced.

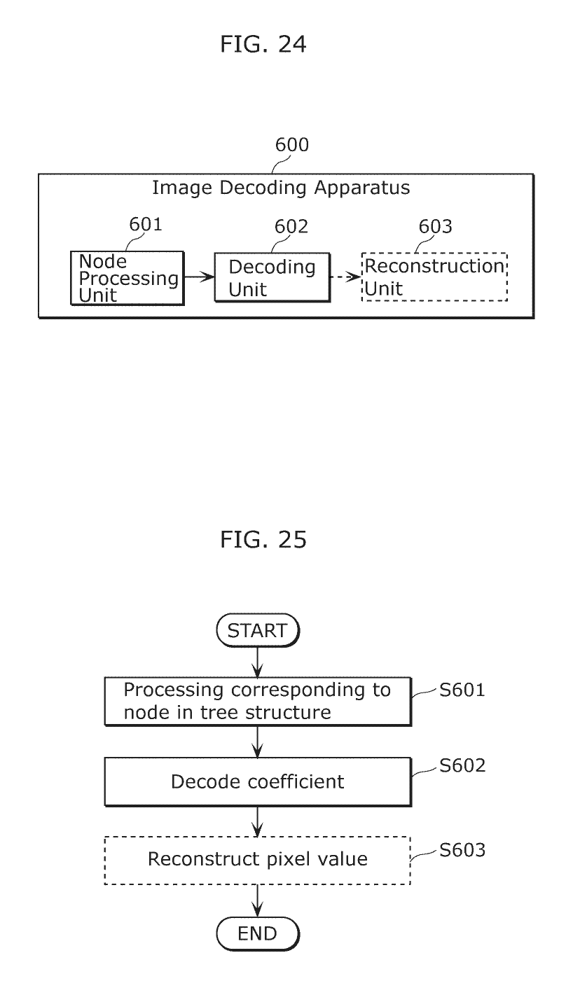

FIG. 24 shows an image decoding apparatus according to the present embodiment. As shown in FIG. 24, the image decoding apparatus 600 includes a node processing unit 601 and a decoding processing unit 602. The image decoding apparatus 600 may further include a reconstruction unit 603. It is also possible that the reconstruction unit 603 is not included in the image decoding apparatus 600.

The node processing unit 601 corresponds to the entropy decoding unit 200, the transform_unified_tree decoding unit 320, and the like which is described in the above embodiments. The decoding processing unit 602 corresponds to the entropy decoding unit 200 and the block transform coefficient decoding unit 316. The reconstruction unit 603 corresponds to the inverse quantization unit 140, the inverse transforming unit 150, the prediction unit 180, the adder 160, and the like.

The following describes each of the structural elements included in the image decoding apparatus 600 in more detail. First, the node processing unit 601 performs node processing on nodes in the tree structure. Here, the tree structure is the same as used in the image coding apparatus 500.

Furthermore, in the node processing, a recursive call of node processing or a call of decoding processing is performed according to a node. The node processing corresponds to transform_unified_tree, transform_tree, and the like described above. The decoding processing corresponds to transform_unified_unit, transform_unit, and the like.

For example, if node processing is performed on a parent node having a child node, the node processing unit 601 recursively calls node processing. Here, the node processing unit 601 assigns (a) a position of an image block corresponding to the child node and (b) a position of an image block corresponding to the parent node, to arguments of the node processing, and recursively calls node processing for the child node.

If node processing is performed on a leaf node, the node processing unit 601 assigns (a) a position of an image block corresponding to the leaf node and (b) a position of an image block corresponding to a parent node of the leaf node, to arguments of decoding processing, and calls the decoding processing.

If node processing is performed for a leaf node by recursively calling node processing, the node processing unit 601 can assign a position given to an argument of the node processing, to an argument of decoding processing. Therefore, the node processing unit 601 does not need to calculate the position of the image block corresponding to the parent node of the leaf node from the position of the image block corresponding to the leaf node.

The decoding processing unit 602 performs decoding processing for decoding a frequency coefficient of an image block. In decoding processing, (a) a frequency coefficient of an image block corresponding to a leaf node or (b) a frequency coefficient of an image block corresponding to a parent node of the leaf node is decoded. These image blocks can be specified by the positions assigned to arguments of the decoding processing.

For example, in decoding processing, if the following two conditions are satisfied, a frequency coefficient of a chrominance value of an image block corresponding to a parent node is decoded. The two conditions are (a) that an image block corresponding to a leaf node has a predetermined minimum size and (b) that the number of pieces of data of chrominance values of the image block corresponding to the leaf node is less than the number of pieces of data of luminance values. The above-described conditions are an example, and any other conditions resulting the same may be used.

The reconstruction unit 603 adds (a) a prediction error generated by performing inverse quantization and inverse frequency transform on a decoded frequency coefficient, with (b) a prediction pixel value. As a result, the reconstruction unit 603 reconstructs (a) a pixel value of an image block corresponding to a leaf node, or (b) a pixel value of an image block corresponding to a parent node of the leaf node.

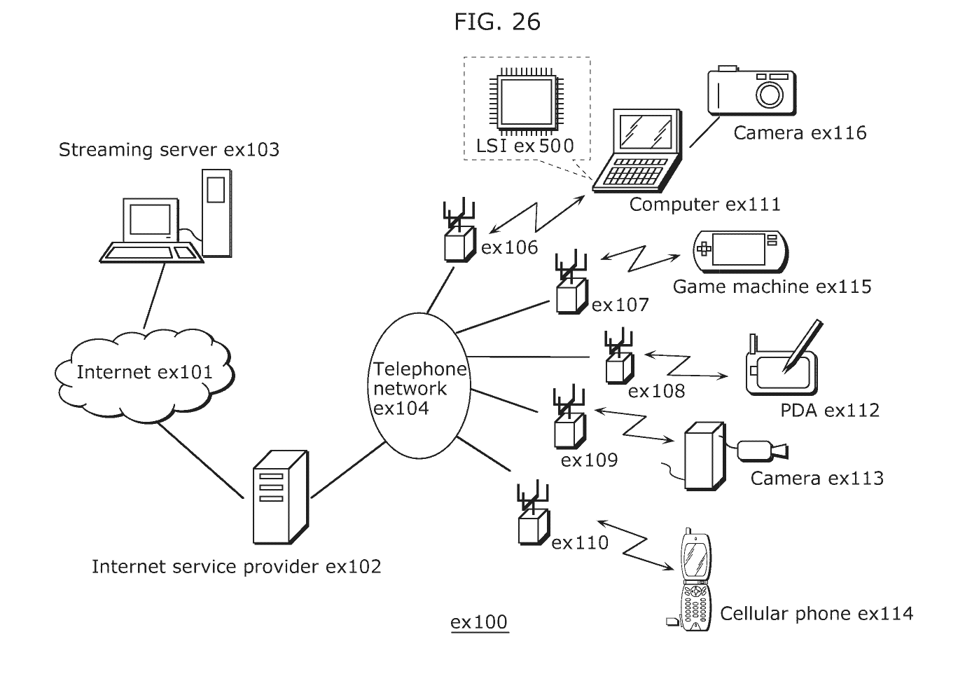

FIG. 25 shows the processing performed by the image decoding apparatus 600 shown in FIG. 24. First, the node processing unit 601 performs node processing on nodes in the tree structure (S601). If node processing is performed on a parent node, node processing is recursively called for a child node. If node processing is performed on a leaf node, decoding processing is called. Then, the decoding processing unit 602 performs decoding processing on a frequency coefficient (S602). Then, the reconstruction unit 603 reconstructs a pixel value using the decoded frequency coefficient (S603).

The pixel value reconstruction may be performed by a different apparatus or by a different method. Therefore, the pixel value reconstruction (S603) may be eliminated from the present embodiment.

As described above, the image decoding apparatus 600 uses, as arguments, both (a) a position of an image block corresponding to a child node and (b) a position of an image block corresponding to a parent node. As a result, a calculation amount for calculating positions of image blocks is reduced.

In each of the above-described embodiments, each of structural elements may be implemented as a dedicated hardware or executed by a software program suitable for the structural element. Each of the structural elements may be implemented when a program execution unit, such as a Central Processing Unit (CPU) or a processor, reads a software program from a recording medium, such as a hard disk or a semiconductor memory, and then executes the readout software program. The software for implementing the display control devices according to the above-described embodiments is as follows.

A program causes to execute an image coding method including: performing node processing on a node from among nodes in a tree structure having relationships by which each of image blocks generated by splitting an image block corresponding to a parent node into child nodes corresponds to a corresponding one of the child nodes; and performing coding processing of coding one of (a) a frequency coefficient of an image block corresponding to a leaf node in the tree structure and (b) a frequency coefficient of an image block corresponding to a parent node of the leaf node, wherein the performing of the node processing includes: when the node processing is performed on a parent node having child nodes, (i) assigning (a) a position of an image block corresponding to a current child node from among the child nodes and (b) a position of an image block corresponding to the parent node, to arguments of the node processing, and (ii) recursively calling the node processing for the current child node, and when the node processing is performed on a leaf node, (i) assigning (a) a position of an image block corresponding to the leaf node and (b) a position of an image block corresponding to a parent node of the leaf node, to arguments of the coding processing, and (ii) calling the coding processing.

A program causes to execute an image decoding method including: performing node processing on a node from among nodes in a tree structure having relationships by which each of image blocks generated by splitting an image block corresponding to a parent node into child nodes corresponds to a corresponding one of the child nodes; and performing decoding processing of decoding one of (a) a frequency coefficient of an image block corresponding to a leaf node in the tree structure and (b) a frequency coefficient of an image block corresponding to a parent node of the leaf node, wherein the performing of the node processing includes: when the node processing is performed on a parent node having child nodes, (i) assigning (a) a position of an image block corresponding to a current child node from among the child nodes and (b) a position of an image block corresponding to the parent node, to arguments of the node processing, and (ii) recursively calling the node processing for the current child node, and when the node processing is performed on a leaf node, (i) assigning (a) a position of an image block corresponding to the leaf node and (b) a position of an image block corresponding to a parent node of the leaf node, to arguments of the decoding processing, and (ii) calling the decoding processing.

It should be noted that each of the structural elements may be a circuit. These circuits may be implemented into a single circuit, or may be implemented into different separate circuits. It should be noted that each of the structural elements may be implemented into a general-purpose processor, or a dedicated processor.

Although the plurality of embodiments have been described as above, the claims are not limited to these embodiments. Those skilled in the art will be readily appreciated that various modifications of the exemplary embodiments and combinations of the structural elements of the different embodiments are possible without materially departing from the novel teachings and advantages of the present invention. Accordingly, all such modifications and combinations are intended to be included within the scope of the present disclosure.

For example, the image coding/decoding apparatus may include the image coding apparatus and the image decoding apparatus. It is also possible that processing performed by a certain processing unit is performed by a different processing unit. In addition, the order of executing the steps may be changed, or a plurality of steps are performed by parallel.

### Embodiment 8

The processing described in each of embodiments can be simply implemented in an independent computer system, by recording, in a recording medium, a program for implementing the configurations of the moving picture coding method (image coding method) and the moving picture decoding method (image decoding method) described in each of embodiments. The recording media may be any recording media as long as the program can be recorded, such as a magnetic disk, an optical disk, a magnetic optical disk, an IC card, and a semiconductor memory.

Hereinafter, the applications to the moving picture coding method (image coding method) and the moving picture decoding method (image decoding method) described in each of embodiments and systems using thereof will be described. The system has a feature of having an image coding and decoding apparatus that includes an image coding apparatus using the image coding method and an image decoding apparatus using the image decoding method. Other configurations in the system can be changed as appropriate depending on the cases.

FIG. 26 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 26, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital camera, is capable of capturing both still images and video. Furthermore, the cellular phone ex114 may be the one that meets any of the standards such as Global System for Mobile Communications (GSM) (registered trademark), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded as described above in each of embodiments (i.e., the camera functions as the image coding apparatus according to an aspect of the present disclosure), and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data (i.e., functions as the image decoding apparatus according to an aspect of the present disclosure).

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the video data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

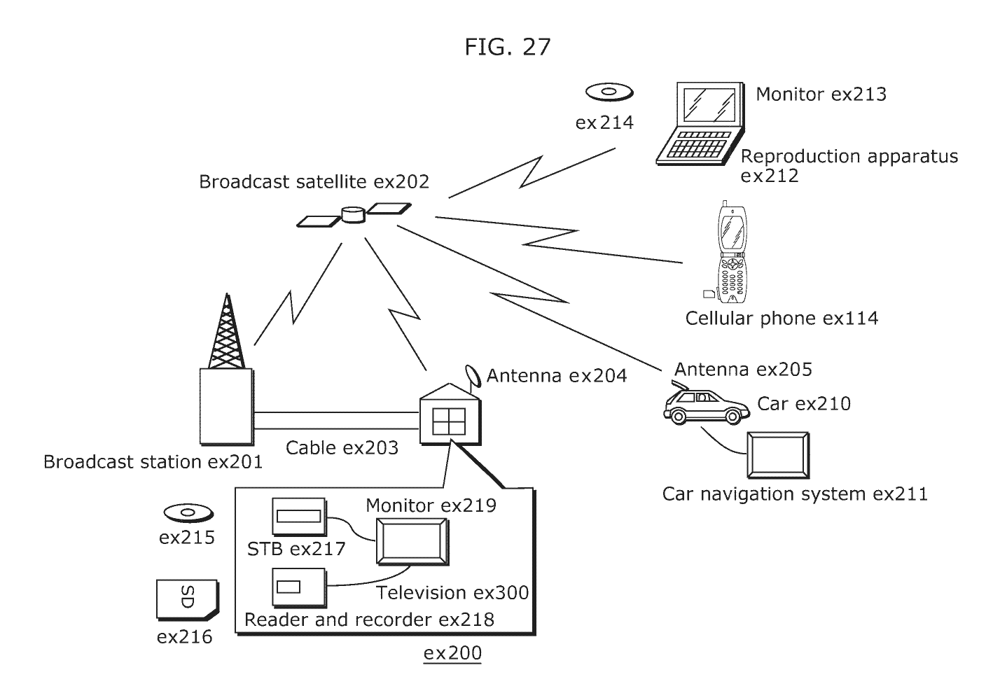

Aside from the example of the content providing system ex100, at least one of the moving picture coding apparatus (image coding apparatus) and the moving picture decoding apparatus (image decoding apparatus) described in each of embodiments may be implemented in a digital broadcasting system ex200 illustrated in FIG. 27. More specifically, a broadcast station ex201 communicates or transmits, via radio waves to a broadcast satellite ex202, multiplexed data obtained by multiplexing audio data and others onto video data. The video data is data coded by the moving picture coding method described in each of embodiments (i.e., data coded by the image coding apparatus according to an aspect of the present disclosure). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data, and reproduces the decoded data (i.e., functions as the image decoding apparatus according to an aspect of the present disclosure).

Furthermore, a reader/recorder ex218 (i) reads and decodes the multiplexed data recorded on a recording medium ex215, such as a DVD and a BD, or (i) codes video signals in the recording medium ex215, and in some cases, writes data obtained by multiplexing an audio signal on the coded data. The reader/recorder ex218 can include the moving picture decoding apparatus or the moving picture coding apparatus as shown in each of embodiments. In this case, the reproduced video signals are displayed on the monitor ex219, and can be reproduced by another device or system using the recording medium ex215 on which the multiplexed data is recorded. It is also possible to implement the moving picture decoding apparatus in the set top box ex217 connected to the cable ex203 for a cable television or to the antenna ex204 for satellite and/or terrestrial broadcasting, so as to display the video signals on the monitor ex219 of the television ex300. The moving picture decoding apparatus may be implemented not in the set top box but in the television ex300.

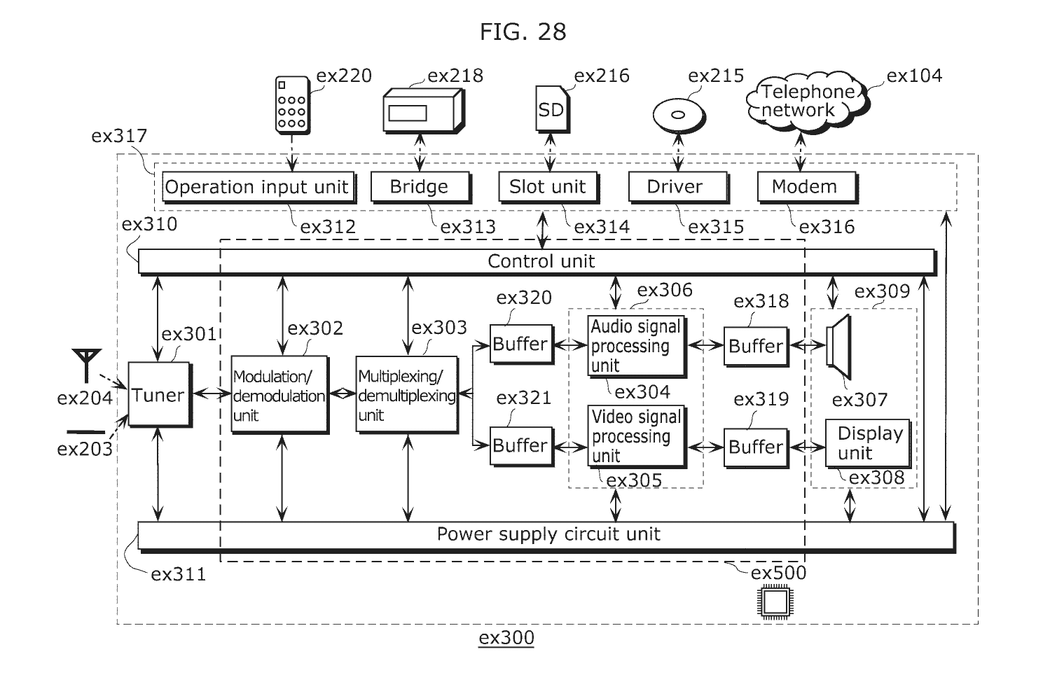

FIG. 28 illustrates the television (receiver) ex300 that uses the moving picture coding method and the moving picture decoding method described in each of embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively (which function as the image coding apparatus and the image decoding apparatus according to the aspects of the present disclosure); and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

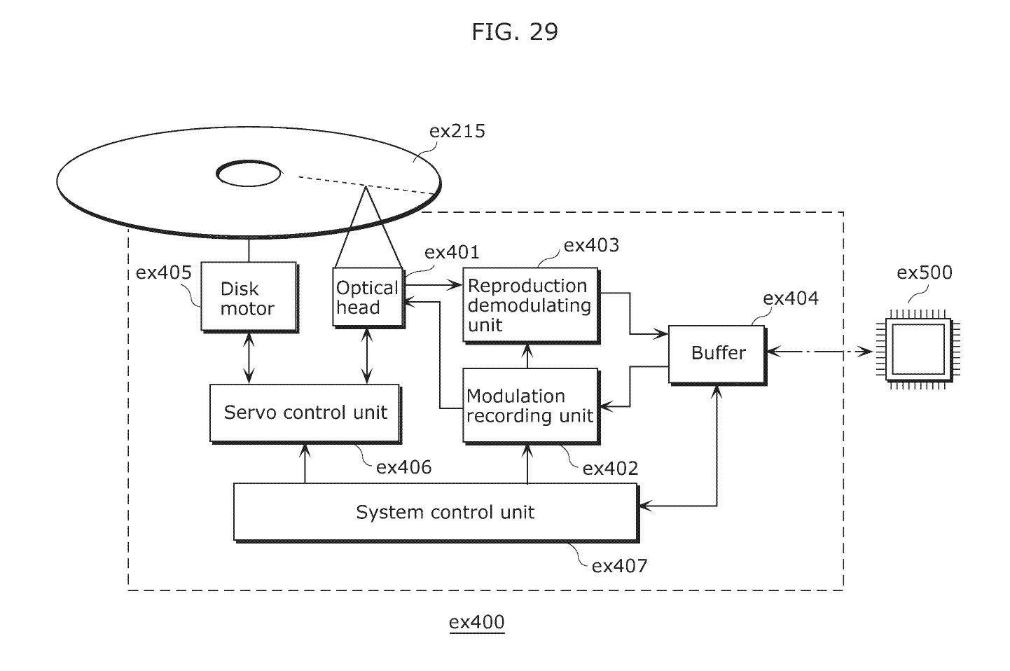

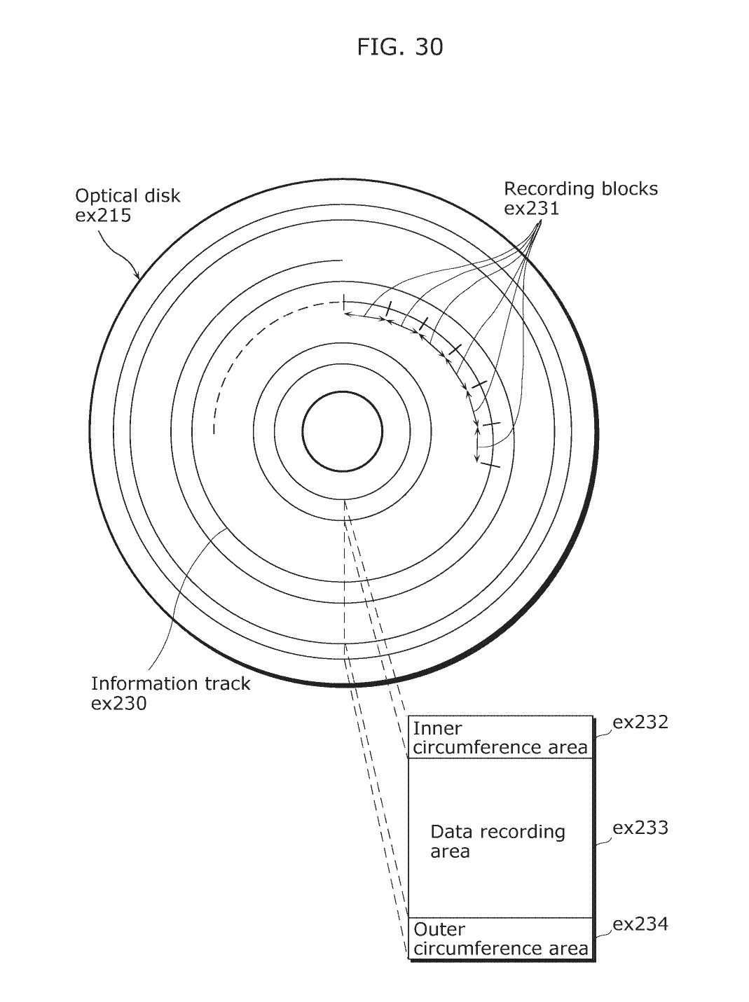

As an example, FIG. 29 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

FIG. 30 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 28. The same will be true for the configuration of the computer ex111, the cellular phone ex114, and others.

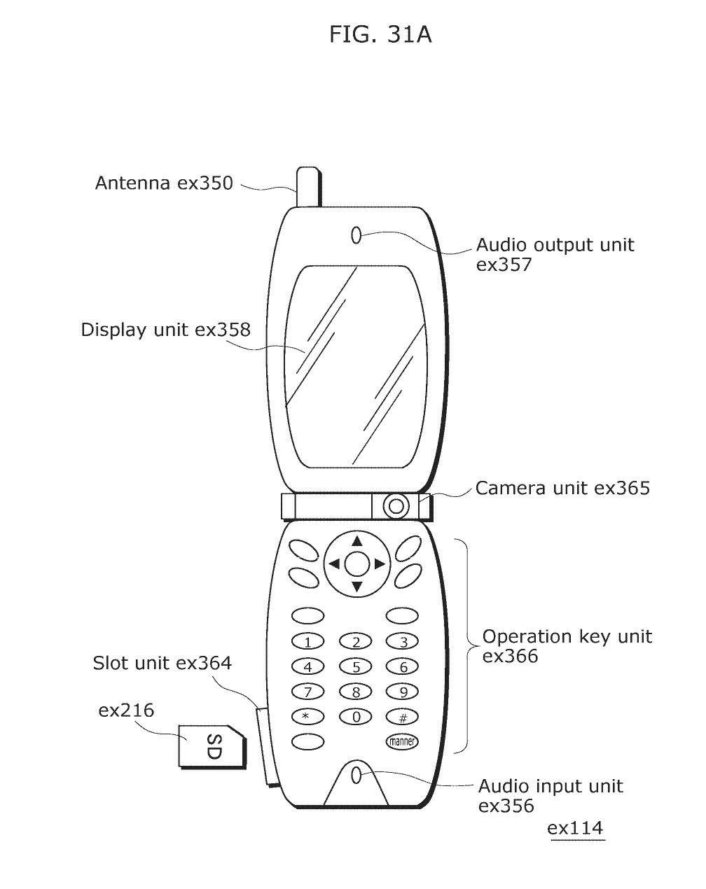

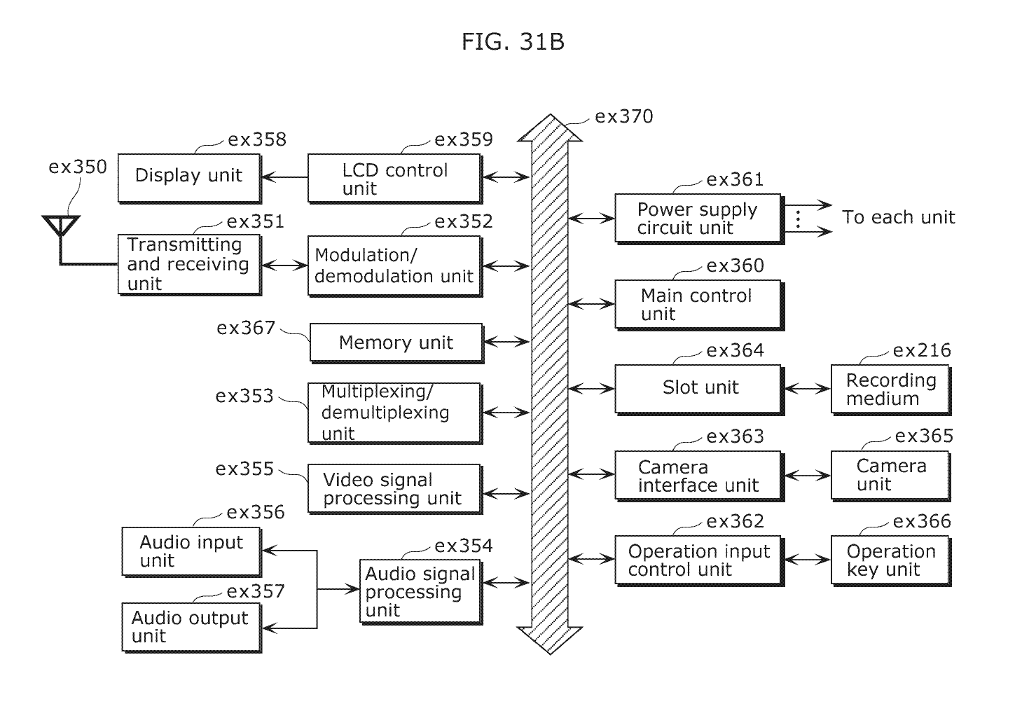

FIG. 31A illustrates the cellular phone ex114 that uses the moving picture coding method and the moving picture decoding method described in embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 31B. In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex357.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the moving picture coding method shown in each of embodiments (i.e., functions as the image coding apparatus according to the aspect of the present disclosure), and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method. Then, the modulation/demodulation unit (modulation/demodulation circuit unit) ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a moving picture decoding method corresponding to the moving picture coding method shown in each of embodiments (i.e., functions as the image decoding apparatus according to the aspect of the present disclosure), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method and the moving picture decoding method in each of embodiments can be used in any of the devices and systems described. Thus, the advantages described in each of embodiments can be obtained.

Furthermore, various modifications and revisions can be made in any of the embodiments in the present disclosure.

### Embodiment 9

Video data can be generated by switching, as necessary, between (i) the moving picture coding method or the moving picture coding apparatus shown in each of embodiments and (ii) a moving picture coding method or a moving picture coding apparatus in conformity with a different standard, such as MPEG-2, MPEG-4 AVC, and VC-1.

Here, when a plurality of video data that conforms to the different standards is generated and is then decoded, the decoding methods need to be selected to conform to the different standards. However, since to which standard each of the plurality of the video data to be decoded conform cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture coding method and by the moving picture coding apparatus shown in each of embodiments will be hereinafter described. The multiplexed data is a digital stream in the MPEG-2 Transport Stream format.

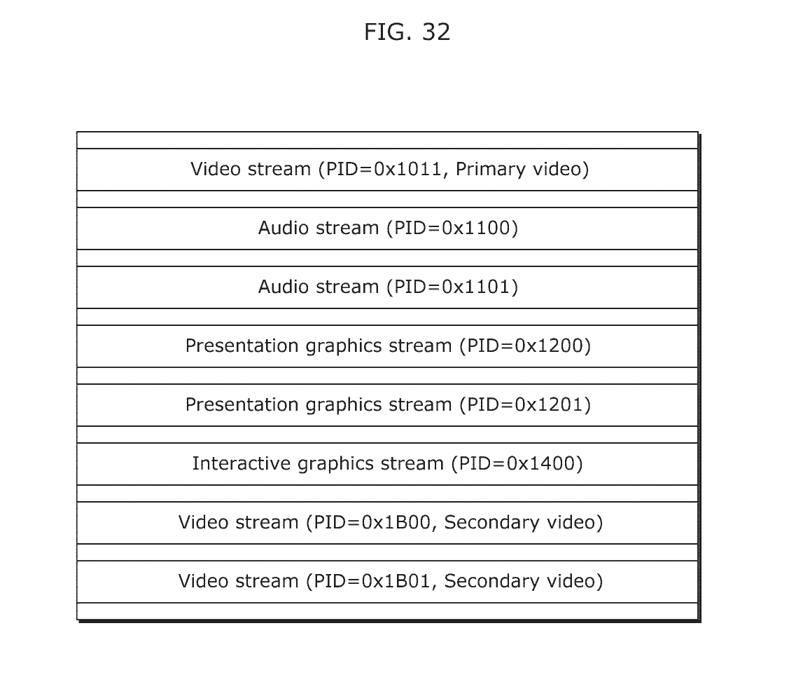

FIG. 32 illustrates a structure of the multiplexed data. As illustrated in FIG. 32, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the moving picture coding method or by the moving picture coding apparatus shown in each of embodiments, or in a moving picture coding method or by a moving picture coding apparatus in conformity with a conventional standard, such as MPEG-2, MPEG-4 AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary audio to be mixed with the primary audio.

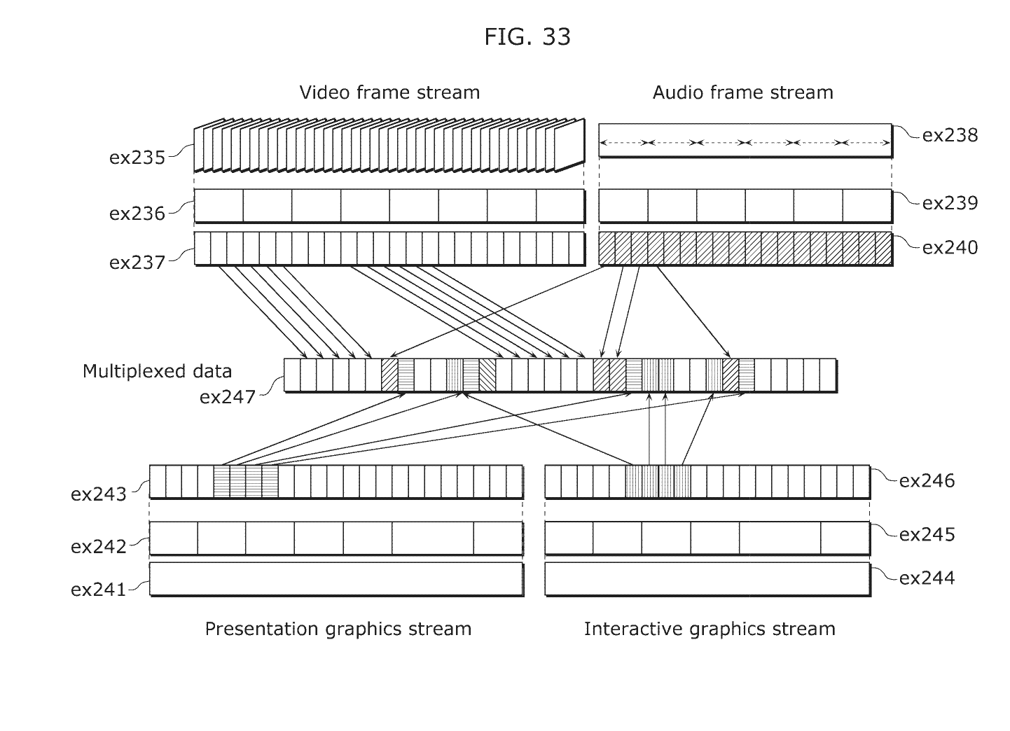

FIG. 33 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

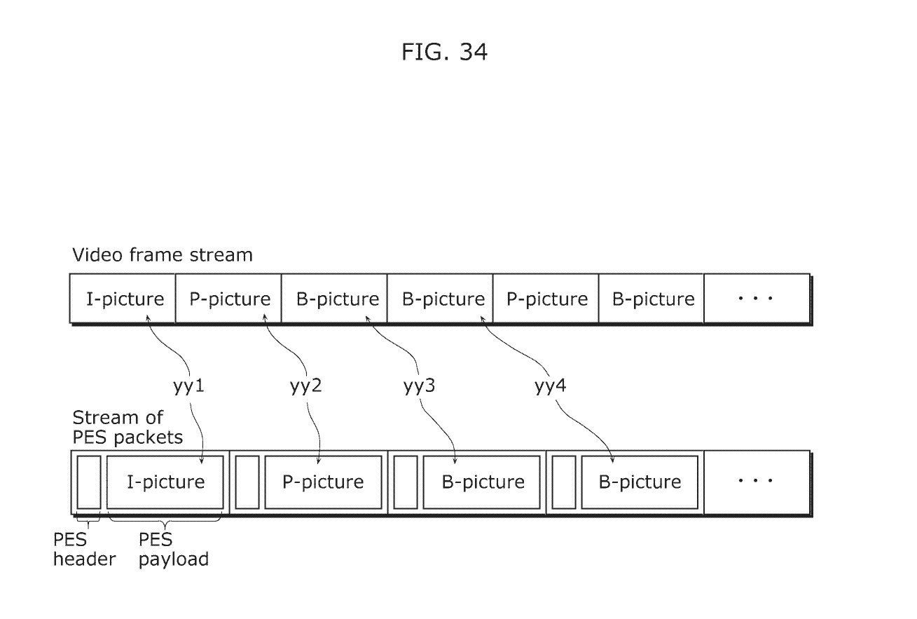

FIG. 34 illustrates how a video stream is stored in a stream of PES packets in more detail. The first bar in FIG. 34 shows a video frame stream in a video stream. The second bar shows the stream of PES packets. As indicated by arrows denoted as yy1, yy2, yy3, and yy4 in FIG. 34, the video stream is divided into pictures as I pictures, B pictures, and P pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

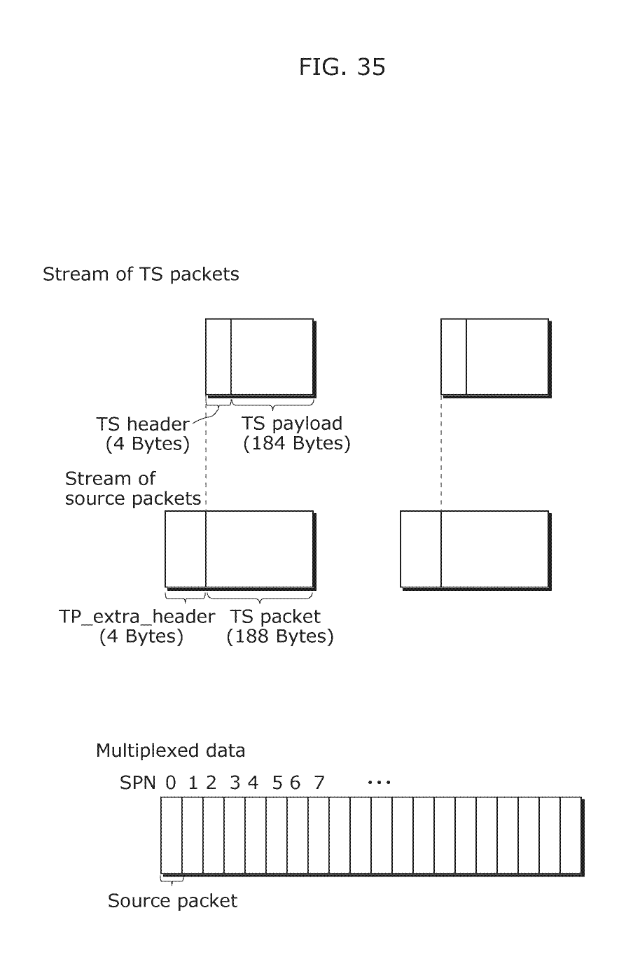

FIG. 35 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 35. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

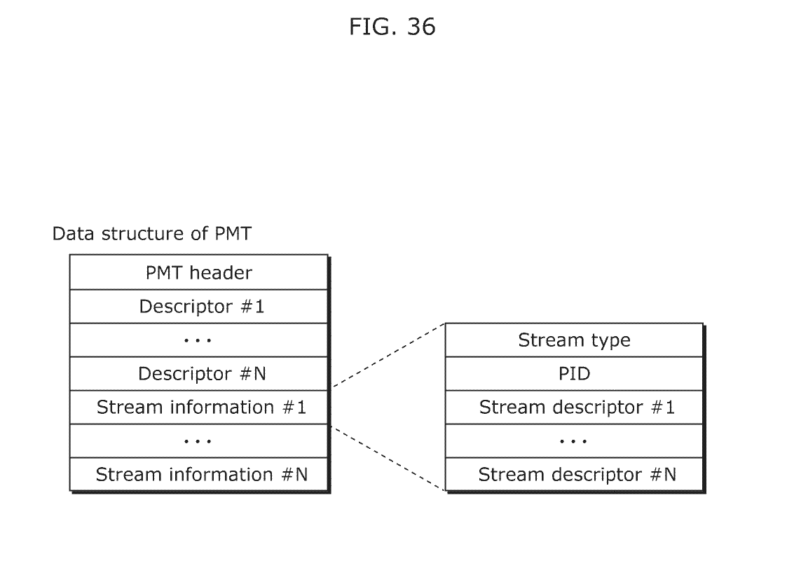

FIG. 36 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

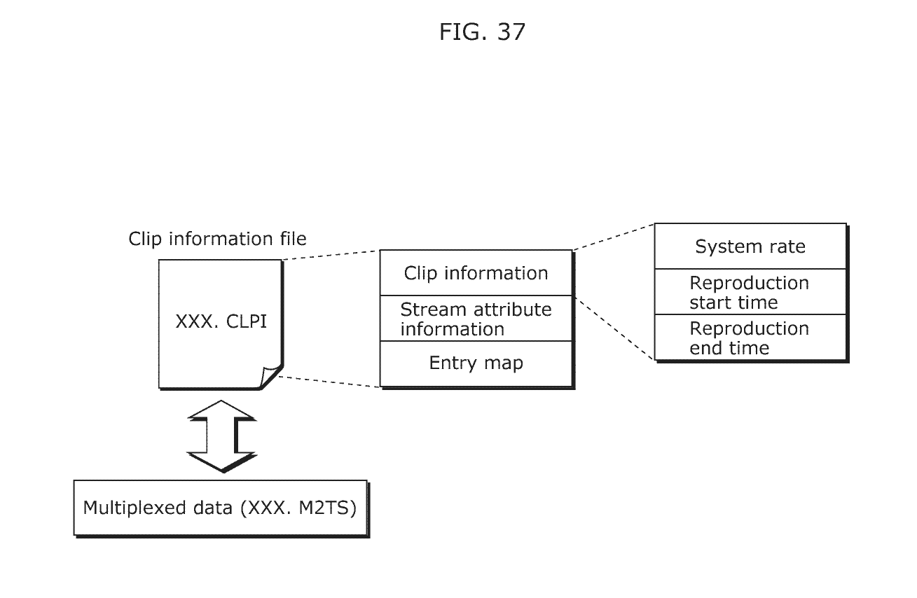

Each of the multiplexed data information files is management information of the multiplexed data as shown in FIG. 37. The multiplexed data information files are in one to one correspondence with the multiplexed data, and each of the files includes multiplexed data information, stream attribute information, and an entry map.

As illustrated in FIG. 37, the multiplexed data information includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

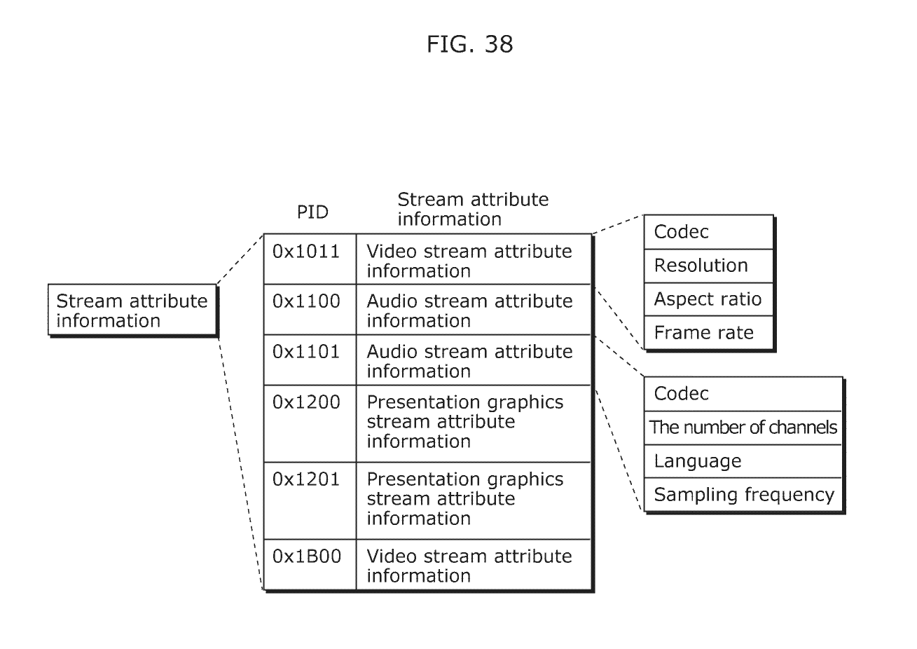

As shown in FIG. 38, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In the present embodiment, the multiplexed data to be used is of a stream type included in the PMT. Furthermore, when the multiplexed data is recorded on a recording medium, the video stream attribute information included in the multiplexed data information is used. More specifically, the moving picture coding method or the moving picture coding apparatus described in each of embodiments includes a step or a unit for allocating unique information indicating video data generated by the moving picture coding method or the moving picture coding apparatus in each of embodiments, to the stream type included in the PMT or the video stream attribute information. With the configuration, the video data generated by the moving picture coding method or the moving picture coding apparatus described in each of embodiments can be distinguished from video data that conforms to another standard.

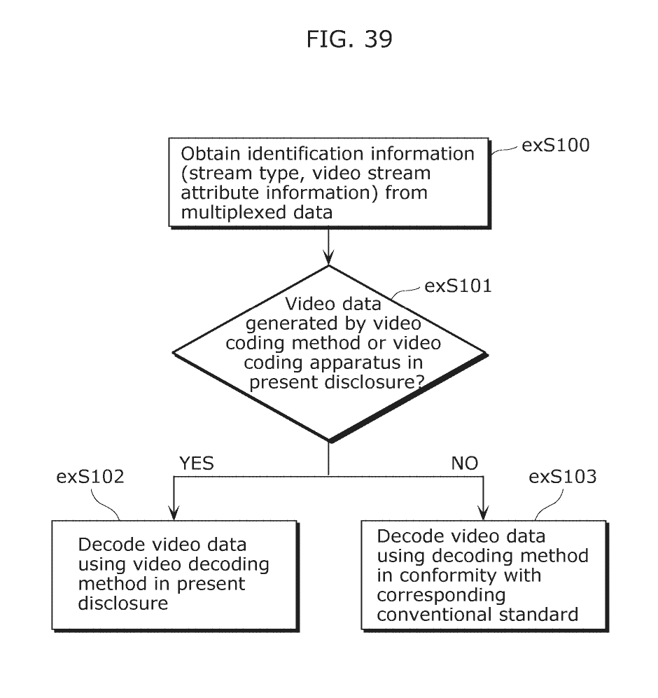

Furthermore, FIG. 39 illustrates steps of the moving picture decoding method according to the present embodiment. In Step exS100, the stream type included in the PMT or the video stream attribute information included in the multiplexed data information is obtained from the multiplexed data. Next, in Step exS101, it is determined whether or not the stream type or the video stream attribute information indicates that the multiplexed data is generated by the moving picture coding method or the moving picture coding apparatus in each of embodiments. When it is determined that the stream type or the video stream attribute information indicates that the multiplexed data is generated by the moving picture coding method or the moving picture coding apparatus in each of embodiments, in Step exS102, decoding is performed by the moving picture decoding method in each of embodiments. Furthermore, when the stream type or the video stream attribute information indicates conformance to the conventional standards, such as MPEG-2, MPEG-4 AVC, and VC-1, in Step exS103, decoding is performed by a moving picture decoding method in conformity with the conventional standards.

As such, allocating a new unique value to the stream type or the video stream attribute information enables determination whether or not the moving picture decoding method or the moving picture decoding apparatus that is described in each of embodiments can perform decoding. Even when multiplexed data that conforms to a different standard is input, an appropriate decoding method or apparatus can be selected. Thus, it becomes possible to decode information without any error. Furthermore, the moving picture coding method or apparatus, or the moving picture decoding method or apparatus in the present embodiment can be used in the devices and systems described above.

### Embodiment 10

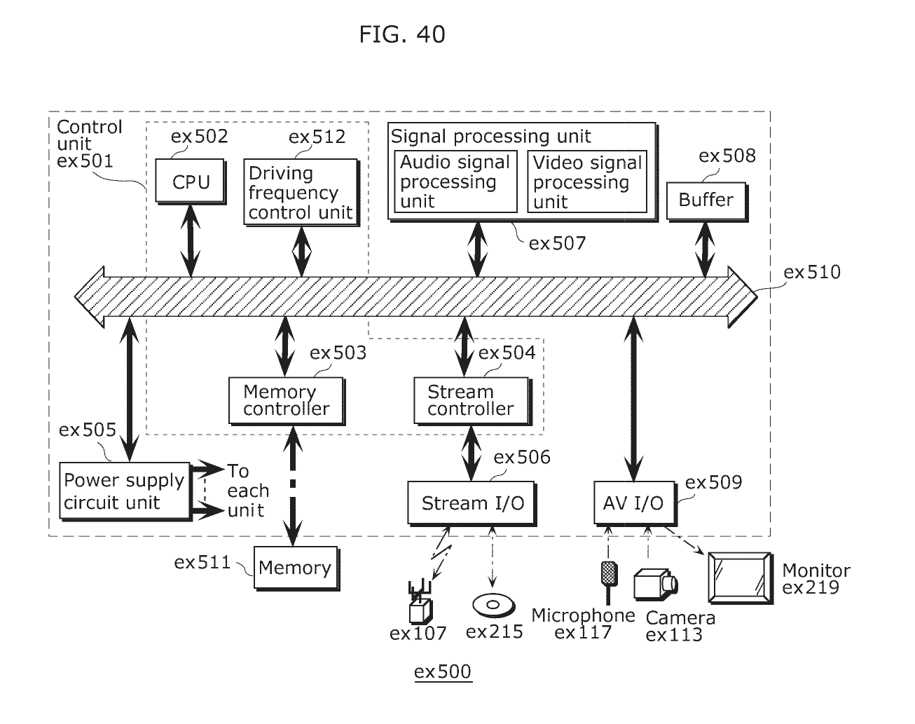

Each of the moving picture coding method, the moving picture coding apparatus, the moving picture decoding method, and the moving picture decoding apparatus in each of embodiments is typically achieved in the form of an integrated circuit or a Large Scale Integrated (LSI) circuit. As an example of the LSI, FIG. 40 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of embodiments. Furthermore, the signal processing unit ex507 sometimes multiplexes the coded audio data and the coded video data, and a stream IO ex506 provides the multiplexed data outside. The provided multiplexed data is transmitted to the base station ex107, or written on the recording medium ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex501 includes the CPU ex502, the memory controller ex503, the stream controller ex504, the driving frequency control unit ex512, the configuration of the control unit ex501 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose. Such a programmable logic device can typically execute the moving picture coding method and/or the moving picture decoding method according to any of the above embodiments, by, loading or reading from a memory or the like one or more programs that are included in software or firmware.

In the future, with advancement in semiconductor technology, a brand-new technology may replace LSI. The functional blocks can be integrated using such a technology. The possibility is that the present disclosure is applied to biotechnology.

### Embodiment 11

When video data generated in the moving picture coding method or by the moving picture coding apparatus described in each of embodiments is decoded, compared to when video data that conforms to a conventional standard, such as MPEG-2, MPEG-4 AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

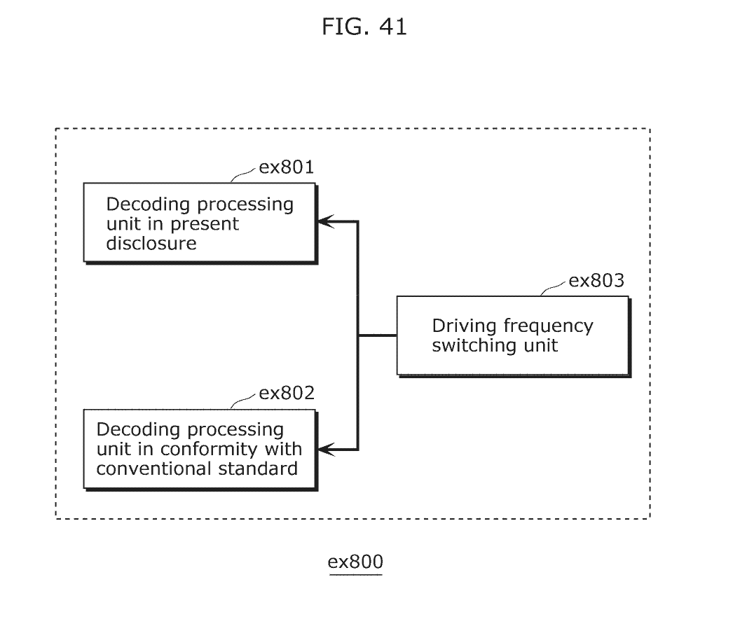

In order to solve the problem, the moving picture decoding apparatus, such as the television ex300 and the LSI ex500 is configured to determine to which standard the video data conforms, and switch between the driving frequencies according to the determined standard. FIG. 41 illustrates a configuration ex800 in the present Embodiment 8 driving frequency switching unit ex803 sets a driving frequency to a higher driving frequency when video data is generated by the moving picture coding method or the moving picture coding apparatus described in each of embodiments. Then, the driving frequency switching unit ex803 instructs a decoding processing unit ex801 that executes the moving picture decoding method described in each of embodiments to decode the video data. When the video data conforms to the conventional standard, the driving frequency switching unit ex803 sets a driving frequency to a lower driving frequency than that of the video data generated by the moving picture coding method or the moving picture coding apparatus described in each of embodiments. Then, the driving frequency switching unit ex803 instructs the decoding processing unit ex802 that conforms to the conventional standard to decode the video data.

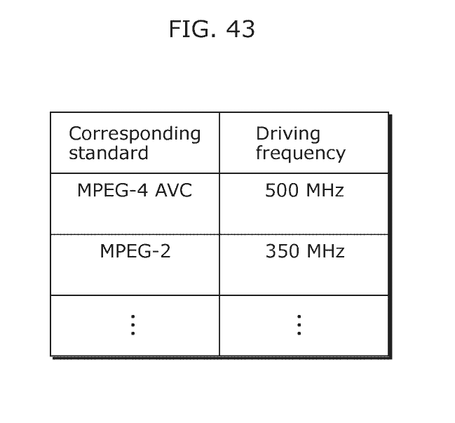

More specifically, the driving frequency switching unit ex803 includes the CPU ex502 and the driving frequency control unit ex512 in FIG. 40. Here, each of the decoding processing unit ex801 that executes the moving picture decoding method described in each of embodiments and the decoding processing unit ex802 that conforms to the conventional standard corresponds to the signal processing unit ex507 in FIG. 40. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described in Embodiment 9 is probably used for identifying the video data. The identification information is not limited to the one described in Embodiment 9 but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 43. The driving frequency can be selected by storing the look-up table in the buffer ex508 and in an internal memory of an LSI, and with reference to the look-up table by the CPU ex502.

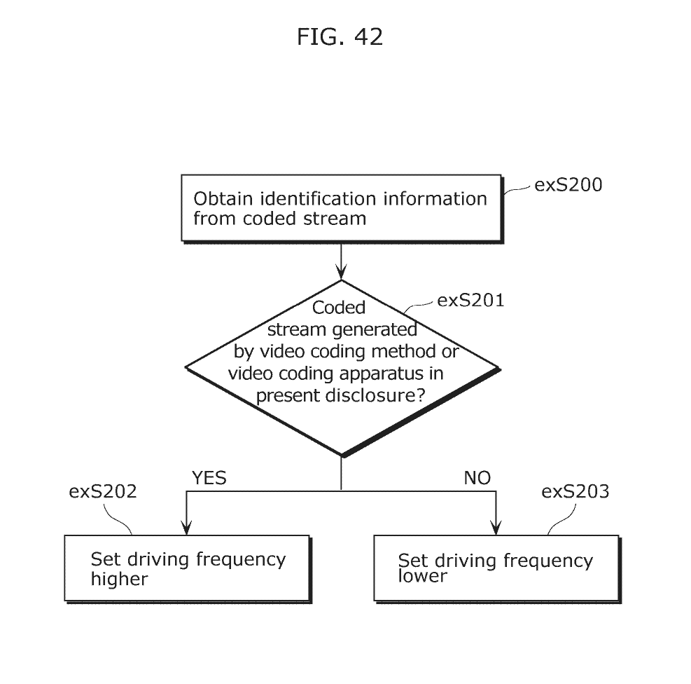

FIG. 42 illustrates steps for executing a method in the present embodiment. First, in Step exS200, the signal processing unit ex507 obtains identification information from the multiplexed data. Next, in Step exS201, the CPU ex502 determines whether or not the video data is generated by the coding method and the coding apparatus described in each of embodiments, based on the identification information. When the video data is generated by the moving picture coding method and the moving picture coding apparatus described in each of embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG-4 AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the moving picture coding method and the moving picture coding apparatus described in each of embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG-4 AVC is larger than the processing amount for decoding video data generated by the moving picture coding method and the moving picture coding apparatus described in each of embodiments, the driving frequency is probably set in reverse order to the setting described above.

Furthermore, the method for setting the driving frequency is not limited to the method for setting the driving frequency lower. For example, when the identification information indicates that the video data is generated by the moving picture coding method and the moving picture coding apparatus described in each of embodiments, the voltage to be applied to the LSI ex500 or the apparatus including the LSI ex500 is probably set higher. When the identification information indicates that the video data conforms to the conventional standard, such as MPEG-2, MPEG-4 AVC, and VC-1, the voltage to be applied to the LSI ex500 or the apparatus including the LSI ex500 is probably set lower. As another example, when the identification information indicates that the video data is generated by the moving picture coding method and the moving picture coding apparatus described in each of embodiments, the driving of the CPU ex502 does not probably have to be suspended. When the identification information indicates that the video data conforms to the conventional standard, such as MPEG-2, MPEG-4 AVC, and VC-1, the driving of the CPU ex502 is probably suspended at a given time because the CPU ex502 has extra processing capacity. Even when the identification information indicates that the video data is generated by the moving picture coding method and the moving picture coding apparatus described in each of embodiments, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, MPEG-4 AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### Embodiment 12

There are cases where a plurality of video data that conforms to different standards, is provided to the devices and systems, such as a television and a cellular phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

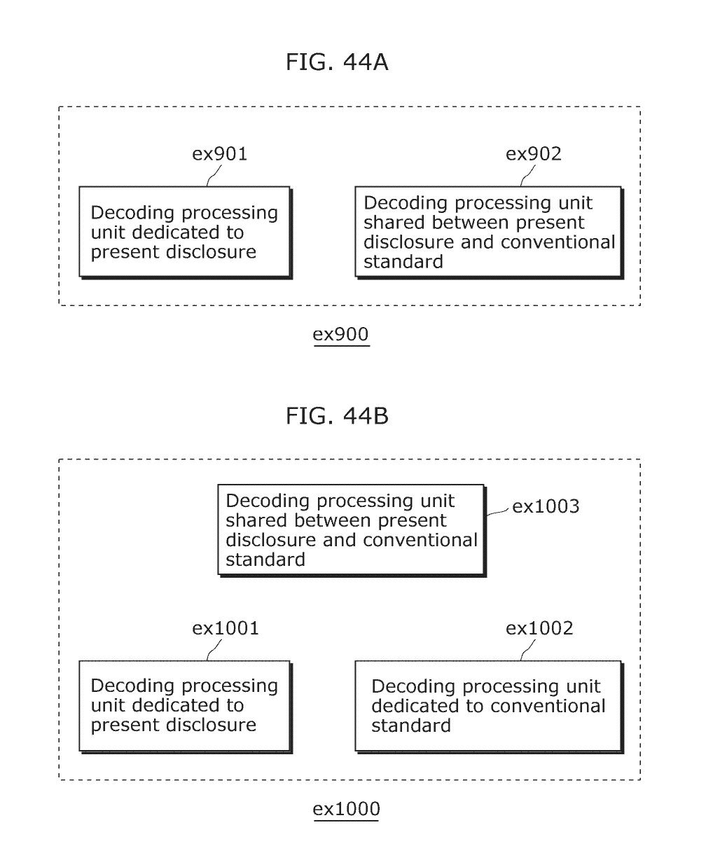

In order to solve the problem, what is conceived is a configuration in which the decoding processing unit for implementing the moving picture decoding method described in each of embodiments and the decoding processing unit that conforms to the conventional standard, such as MPEG-2, MPEG-4 AVC, and VC-1 are partly shared. Ex900 in FIG. 44A shows an example of the configuration. For example, the moving picture decoding method described in each of embodiments and the moving picture decoding method that conforms to MPEG-4 AVC have, partly in common, the details of processing, such as entropy coding, inverse quantization, deblocking filtering, and motion compensated prediction. The details of processing to be shared probably include use of a decoding processing unit ex902 that conforms to MPEG-4 AVC. In contrast, a dedicated decoding processing unit ex901 is probably used for other processing unique to an aspect of the present disclosure. Since the aspect of the present disclosure is characterized by entropy decoding in particular, for example, the dedicated decoding processing unit ex901 is used for entropy decoding. Otherwise, the decoding processing unit is probably shared for one of the inverse quantization, deblocking filtering, and motion compensation, or all of the processing. The decoding processing unit for implementing the moving picture decoding method described in each of embodiments may be shared for the processing to be shared, and a dedicated decoding processing unit may be used for processing unique to that of MPEG-4 AVC.

Furthermore, ex1000 in FIG. 44B shows another example in that processing is partly shared. This example uses a configuration including a dedicated decoding processing unit ex1001 that supports the processing unique to an aspect of the present disclosure, a dedicated decoding processing unit ex1002 that supports the processing unique to another conventional standard, and a decoding processing unit ex1003 that supports processing to be shared between the moving picture decoding method according to the aspect of the present disclosure and the conventional moving picture decoding method. Here, the dedicated decoding processing units ex1001 and ex1002 are not necessarily specialized for the processing according to the aspect of the present disclosure and the processing of the conventional standard, respectively, and may be the ones capable of implementing general processing. Furthermore, the configuration of the present embodiment can be implemented by the LSI ex500.

As such, reducing the scale of the circuit of an LSI and reducing the cost are possible by sharing the decoding processing unit for the processing to be shared between the moving picture decoding method according to the aspect of the present disclosure and the moving picture decoding method in conformity with the conventional standard.

### INDUSTRIAL APPLICABILITY

The present disclosure is usable for, for example, TV sets, digital video recorders, in-vehicle navigation systems, portable phones, digital cameras, digital camcorders, and the like.

1. An image coding method comprising:
performing node processing on a node from among nodes in a tree structure having relationships by which each of image blocks generated by splitting an image block corresponding to a parent node into child nodes corresponds to a corresponding one of the child nodes; and
performing coding processing of coding one of (a) a frequency coefficient of an image block corresponding to a leaf node in the tree structure and (b) a frequency coefficient of an image block corresponding to a parent node of the leaf node,
wherein the performing of the node processing includes:
when the node processing is performed on a parent node having child nodes, (i) assigning (a) a position of an image block corresponding to a current child node from among the child nodes and (b) a position of an image block corresponding to the parent node, to arguments of the node processing, and (ii) recursively calling the node processing for the current child node, and
when the node processing is performed on a leaf node, (i) assigning (a) a position of an image block corresponding to the leaf node and (b) a position of an image block corresponding to a parent node of the leaf node, to arguments of the coding processing, and (ii) calling the coding processing.

2. The image coding method according to claim 1, further comprising
performing frequency transform and quantization on a prediction error between (a) one of (a−1) a pixel value of an image block corresponding to a leaf node in the tree structure and (a−2) a pixel value of an image block corresponding to a parent node of the leaf node and (b) a prediction pixel value, thereby generating the frequency coefficient,
wherein in the performing of the coding processing, the generated frequency coefficient is coded.

3. The image coding method according to claim 1,
wherein, when the image block corresponding to the leaf node has a predetermined minimum size and a total number of pieces of data of a chrominance value of the image block corresponding to the leaf node is less than a total number of pieces of data of a luminance value, the performing of the coding processing includes: (i) specifying the image block corresponding to the parent node of the leaf node according to the position of the image block corresponding to the parent node; and (ii) coding a frequency coefficient of a chrominance value of the image block corresponding to the parent node, the position of the image block corresponding to the parent node being assigned to one of the arguments of the coding processing.

4. The image coding method according to claim 1,
wherein in the performing of the node processing, the node processing is performed on the nodes in the tree structure that has (a) a root node corresponding to a coding unit of an image and (b) a leaf node corresponding to a transform unit of a luminance value in the coding unit.

5. An image decoding method comprising:
performing node processing on a node from among nodes in a tree structure having relationships by which each of image blocks generated by splitting an image block corresponding to a parent node into child nodes corresponds to a corresponding one of the child nodes; and
performing decoding processing of decoding one of (a) a frequency coefficient of an image block corresponding to a leaf node in the tree structure and (b) a frequency coefficient of an image block corresponding to a parent node of the leaf node,
wherein the performing of the node processing includes:
when the node processing is performed on a parent node having child nodes, (i) assigning (a) a position of an image block corresponding to a current child node from among the child nodes and (b) a position of an image block corresponding to the parent node, to arguments of the node processing, and (ii) recursively calling the node processing for the current child node, and
when the node processing is performed on a leaf node, (i) assigning (a) a position of an image block corresponding to the leaf node and (b) a position of an image block corresponding to a parent node of the leaf node, to arguments of the decoding processing, and (ii) calling the decoding processing.

6. The image decoding method according to claim 5, further comprising
adding a prediction pixel value to a prediction error generated by performing inverse quantization and inverse frequency transform on the decoded frequency coefficient, thereby reconstructing one of (a) a pixel value of an image block corresponding to a leaf node in the tree structure and (b) a pixel value of an image block corresponding to a parent node of the leaf node.

7. The image decoding method according to claim 5,
wherein, when the image block corresponding to the leaf node has a predetermined minimum size and a total number of pieces of data of a chrominance value of the image block corresponding to the leaf node is less than a total number of pieces of data of a luminance value, the performing of the decoding processing includes: (i) specifying the image block corresponding to the parent node of the leaf node according to the position of the image block corresponding to the parent node, and (ii) decoding a frequency coefficient of a chrominance value of the image block corresponding to the parent node, the position of the image block corresponding to the parent node being assigned to one of the arguments of the decoding processing.

8. The image decoding method according to claim 5,
wherein in the performing of the node processing, the node processing is performed on the nodes in the tree structure that has (a) a root node corresponding to a coding unit of an image and (b) a leaf node corresponding to a transform unit of a luminance value in the coding unit.

9. An image coding apparatus that executes the image coding method according to claim 1.

10. An image decoding apparatus that executes the image decoding method according to claim 5.

11. The image coding and decoding apparatus comprising:
the image coding apparatus according to claim 9; and
an image decoding apparatus,
wherein the image decoding apparatus includes:
a node processing unit configured to perform node processing on a node from among nodes in a tree structure having relationships by which each of image blocks generated by splitting an image block corresponding to a parent node into child nodes corresponds to a corresponding one of the child nodes; and
a decoding processing unit configured to perform decoding processing of decoding one of (a) a frequency coefficient of an image block corresponding to a leaf node in the tree structure and (b) a frequency coefficient of an image block corresponding to a parent node of the leaf node,
wherein the node processing unit is configured to:
when the node processing is performed on a parent node having child nodes, (i) assign (a) a position of an image block corresponding to a current child node from among the child nodes and (b) a position of an image block corresponding to the parent node, to arguments of the node processing, and (ii) recursively call the node processing for the current child node, and
when the node processing is performed on a leaf node, (i) assign (a) a position of an image block corresponding to the leaf node and (b) a position of an image block corresponding to a parent node of the leaf node, to arguments of the decoding processing, and (ii) call the decoding processing.
